(19) United States
(12) Patent Application Publication
(10) Pub. No.: US 2023/0072790 A1
(43) Pub. Date: Mar. 9, 2023

(54) COMPOUNDS AND FORMULATIONS FOR PROTECTIVE COATINGS

(71) Applicant: Apeel Technology, Inc., Goleta, CA (US)

(72) Inventors: Mina Faust, Goleta, CA (US); Ronald C. Bakus, Goleta, CA (US); Stanley Zhang, Goleta, CA (US); Stephen William Kaun, Santa Barbara, CA (US); David Fisher, Goleta, CA (US); Justin Ryan, Goleta, CA (US)

(21) Appl. No.: 17/941,745

(22) Filed: Sep. 9, 2022

Related U.S. Application Data
(60) Provisional application No. 63/242,477, filed on Sep. 9, 2021.

(51) Int. Cl. A01N 3/00; A23B 7/08

(52) U.S. Cl. CPC A01N 3/00; A23B 7/085

(57) ABSTRACT

Compositions for forming protective coatings on, e.g., agricultural products, can form a bilayer structure on the surface of the agricultural product that forms a barrier to fluids such as water and gases.

### CROSS REFERENCE TO RELATED APPLICATION

This application claims priority to U.S. Provisional Application Serial No. 63/242,477, filed on Sep. 9, 2021, the disclosure of which is incorporated by reference in its entirety.

### TECHNICAL FIELD

This invention relates to compounds and formulations for coatings that are applied to agricultural products and methods of application and use thereof.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Edible non-agricultural products (e.g., vitamins, candy, etc.) can also be vulnerable to degradation when exposed to the ambient environment. The degradation of agricultural and other edible products can occur via abiotic means as a result of evaporative moisture loss from an external surface of the products to the atmosphere, oxidation by oxygen that diffuses into the products from the environment, mechanical damage to the surface, and/or light-induced degradation (i.e., photodegradation). Biotic stressors such as bacteria, fungi, viruses, and/or pests can also infest and decompose the products.

The cells that form the aerial surface of most plants (such as higher plants) include an outer envelope or cuticle, which provides varying degrees of protection against water loss, oxidation, mechanical damage, photodegradation, and/or biotic stressors, depending upon the plant species and the plant organ (e.g., fruit, seeds, bark, flowers, leaves, stems, etc.). Cutin, which is a biopolyester derived from cellular lipids, forms the major structural component of the cuticle and serves to provide protection to the plant against environmental stressors (both abiotic and biotic). The thickness, density, as well as the composition of the cutin (i.e., the different types of monomers that form the cutin and their relative proportions) can vary by plant species, by plant organ within the same or different plant species, and by stage of plant maturity. The cutin-containing portion of the plant can also contain additional compounds (e.g., epicuticular waxes, phenolics, antioxidants, colored compounds, proteins, polysaccharides, etc.). This variation in the cutin composition as well as the thickness and density of the cutin layer between plant species, plant organs and/or a given plant at different stages of maturation can lead to varying degrees of resistance between plant species or plant organs to attack by environmental stressors (i.e., water loss, oxidation, mechanical injury, and light) and/or biotic stressors (e.g., fungi, bacteria, viruses, insects, etc.).

Conventional approaches to preventing degradation, maintaining quality, and increasing the life of agricultural products include special packaging and/or refrigeration. Refrigeration requires capital-intensive equipment, demands constant energy expenditure, can cause damage or quality loss to the product if not carefully controlled, must be actively managed, and its benefits are lost upon interruption of a temperature-controlled supply chain. Produce mass loss (e.g., water loss) during storage increases humidity, which necessitates careful maintenance of relative humidity levels (e.g., using condensers) to avoid negative impacts (e.g., condensation, microbial proliferation, etc.) during storage. Moreover, respiration of agricultural products is an exothermic process which releases heat into the surrounding atmosphere. During transit and storage in shipping containers, heat generated by the respiration of the agricultural product, as well as external environmental conditions and heat generated from mechanical processes (e.g., motors) necessitates active cooling of the storage container in order to maintain the appropriate temperature for storage, which is a major cost driver for shipping companies. By reducing the rate of degradation, reducing the heat generation in storage and transit, and increasing the shelf life of agricultural products, there is a direct value to the key stakeholders throughout the supply chain.

There exists a need for new, more cost-effective approaches to prevent degradation, reduce the generation of heat and humidity, maintain quality, and increase the life of agricultural products. Such approaches may require less or no refrigeration, special packaging, etc.

### SUMMARY

Compositions and formulations for forming protective coatings and methods of making and using the coatings thereof are described herein. The components of the coatings form structures comprising one or more lamellae on the surface of the substrate (e.g., agricultural product) the coatings are disposed on, thus forming a protective barrier. In some embodiments, the protective barrier exhibits a low water and gas permeability. For example, the lattice formation that the molecules of the lamella adopt and the intermolecular forces between the lamellae can reduce loss of water or gas from the substrate. In some embodiments, the water and gas permeability of the coatings described herein can be modified by, e.g., (1) changing the components or amounts of the components in the composition (e.g., coating agent) applied to the substrate, as well as (2) modifying the method used to form the coating (e.g., the temperature at which the coating agent is mixed, the temperature or speed at which the mixture comprising the coating agent on the substrate is dried, and/or the concentration of the coating agent in the mixture applied to the substrate). In some embodiments, the coating agents and/or coatings formed comprise one or more sucrose or sorbitan esters. In some embodiments, the coatings described herein are a more effective barrier to water and gas than, e.g., conventional wax coatings. In some such embodiments, the thickness of the coating is less than the thickness of conventional wax coatings.

A method of reducing the ripening rate of an agricultural product is also described herein. The method comprises applying a solution comprising one or more sucrose esters, or one or more sorbitan esters, or both to a surface of the agricultural product and drying the solution on the surface of the agricultural product under a flow of air to promote self-assembly of a multiplicity of bilayers on the surface of agricultural product, thereby forming a coating containing the sucrose ester and/or the sorbitan ester on the agricultural product.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a method of reducing the ripening rate of an agricultural product, the method comprising:
applying a dispersion comprising:
   one or more sucrose esters,
   one or more sorbitan esters, or
   one or more sucrose esters and one or more sorbitan esters to a surface of the agricultural product; and
drying the dispersion on the surface of the agricultural product under a flow of air to promote self-assembly of a multiplicity of bilayers on the surface of the agricultural product, thereby forming a coating comprising the one or more sucrose esters, the one or more sorbitan esters, or the one or more sucrose esters and the one or more sorbitan esters on the agricultural product.

Embodiment 2 is the method of embodiment 1, further comprising preparing the dispersion at a temperature between about 50° C. and about 100° C.

Embodiment 3 is the method of embodiment 1, further comprising preparing the dispersion at room temperature.

Embodiment 4 is the method of any one of embodiments 1-3, wherein each of the one or more sucrose esters has an ester chain length of C₁₀ to C₂₄.

Embodiment 5 is the method of any one of embodiments 1-4, wherein the one or more sucrose esters comprise one or more of sucrose palmitate, sucrose stearate, and sucrose laurate.

Embodiment 6 is the method of any one of embodiments 1-5, wherein each of the one or more sorbitan esters has an ester chain length of C₁₀ to C₂₄.

Embodiment 7 is the method of any one of embodiments 1-6, wherein the one or more sorbitan esters comprise one or more of sorbitan stearate, sorbitan palmitate, and sorbitan laurate.

Embodiment 8 is the method of any one of embodiments 1-7, wherein the dispersion comprises a solvent and a coating agent, and the coating agent comprises about 90 wt% to about 100 wt% of a total amount of the one or more sucrose esters and the one or more sorbitan esters.

Embodiment 9 is the method of any one of embodiments 1-8, wherein the dispersion further comprises one or more fatty acid derivatives.

Embodiment 10 is the method of any one of embodiments 1-9, wherein a total concentration of the one or more sucrose esters and the one or more sorbitan esters in the dispersion is between about 30 mg/mL and about 125 mg/mL.

Embodiment 11 is the method of any one of embodiments 1-9, wherein a total concentration of the one or more sucrose esters and one or more sorbitan esters in the dispersion is between about 1 mg/mL and about 5 mg/mL.

Embodiment 12 is the method of any one of embodiments 1-11, wherein the dispersion is an aqueous solution.

Embodiment 13 is the method of any one of embodiments 1-12, wherein the dispersion is free of added stabilizer.

Embodiment 14 is the method of any one of embodiments 1-13, wherein the dispersion is free of added surfactant.

Embodiment 15 is the method of any one of embodiments 1-14, wherein a temperature of the air is between about 50° C. and about 100° C.

Embodiment 16 is the method of any one of embodiments 1-15, wherein the multiplicity of bilayers comprises one or more open bilayers.

Embodiment 17 is the method of embodiment 16, wherein each bilayer in the multiplicity of bilayers is an open bilayer.

Embodiment 18 is the method of embodiment 16 or embodiment 17, wherein one or more of the open bilayers are lamellar.

Embodiment 19 is the method of any one of embodiments 1-15, wherein the multiplicity of bilayers comprises one or more closed bilayers.

Embodiment 20 is the method of embodiment 19, wherein each bilayer in the multiplicity of bilayers is a closed bilayer.

Embodiment 21 is the method of embodiment 19 or embodiment 20, wherein one or more of the closed bilayers are each independently spherical or cylindrical.

Embodiment 22 is the method of any one of embodiments 1-21, wherein a thickness of the coating is less than about 2 microns.

Embodiment 23 is the method of any one of embodiments 1-22, wherein a thickness of the coating is less than about 1 micron.

Embodiment 24 is a coated agricultural product comprising:
an agricultural product; and
a coating on the surface of the agricultural product, wherein the coating comprises:
   one or more sucrose esters,
   one or more sorbitan esters, or
   one or more sucrose esters and one or more sorbitan esters, and
   a multiplicity of bilayers on the surface of the agricultural product.

Embodiment 25 is the product of embodiment 24, wherein a thickness of the coating is less than about 2 microns.

Embodiment 26 is the product of embodiment 24 or embodiment 25, wherein a thickness of the coating is less than about 1 micron.

Embodiment 27 is the product of any one of embodiments 24-26, wherein the multiplicity of bilayers comprises one or more open bilayers.

Embodiment 28 is the product of embodiment 27, wherein each bilayer in the multiplicity of bilayers is an open bilayer.

Embodiment 29 is the product of embodiment 27 or embodiment 28, wherein one or more of the open bilayers are lamellar.

Embodiment 30 is the product of any one of embodiments 24-26, wherein the multiplicity of bilayers comprises one or more closed bilayers.

Embodiment 31 is the product of embodiment 30, wherein each bilayer in the multiplicity of bilayers is a closed bilayer.

Embodiment 32 is the product of embodiment 30 or embodiment 31, wherein one or more of the closed bilayers are each independently spherical or cylindrical.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 shows a plot of mass loss rates per day for Californian Hass avocados that are untreated, coated with sucrose esters, and coated with monoglyceride coatings.

FIG. 2 shows a plot of mass loss rates per day for Mexican Hass avocados that are untreated, coated with sucrose esters, and coated with monoglyceride coatings.

FIG. 3 shows a plot of mass loss rates per day for red grape tomatoes that are untreated, coated with sucrose esters, and coated with monoglyceride coatings.

FIG. 4 shows a plot of mass loss rates per day for peaches that are untreated, coated with sucrose esters, and coated with a monoglyceride coating.

FIG. 5 shows a plot of mass loss rates per day for peaches that are untreated, coated with sucrose esters, and coated with a monoglyceride coating.

FIG. 6 shows a plot of mass loss factors for agricultural products that are untreated, coated with a monoglyceride coating, and coated with a sucrose ester coating, where the coatings were applied using brush bed and heat tunnel conditions.

FIG. 7 shows a plot of respiration rates for agricultural products that are untreated, coated with a monoglyceride coating, and coated with a sucrose ester coating.

FIG. 8 shows a plot of mass loss factors for Mexican avocados that are untreated, treated with a monoglyceride coating, treated with a cold-mixed 100% sucrose ester coating, and treated with a hot-mixed 100% sucrose ester coating, where the coatings are applied using bowl dip application and heat tunnel drying conditions.

FIG. 9 shows a plot of respiration rates for Mexican avocados that are untreated, treated with a monoglyceride coating, treated with a cold-mixed 100% sucrose ester coating, and treated with a hot-mixed 100% sucrose ester coating.

FIG. 10A is an image of untreated avocados.

FIG. 10B is an image of avocados coated with a hot-mixed 100% sucrose ester coating.

FIG. 11 shows a plot of gloss units for plastic substrates coated with a monoglyceride coating, a cold-mixed 100% sucrose ester coating, a hot-mixed 100% sucrose ester coating, and a 98% sucrose ester coating.

FIG. 12 shows a plot of transmission for two different types of sucrose esters mixed with monostearate.

FIG. 13 shows a plot of turbidity for dispersions of monoglyceride mixtures with sucrose stearate additive.

FIG. 14 shows a plot of turbidity for dispersions of monoglyceride mixtures with sucrose stearate additive.

FIG. 15 shows a plot of intensity vs. q(Å⁻¹) from axis of the x-ray scattering image of a sorbitan monostearate thin-film on a silicon substrate.

FIG. 16 shows a plot of intensity vs. q(Å⁻¹) from axis of the x-ray scattering image of a sorbitan monopalmitate thin-film on a silicon substrate.

FIG. 17 shows a plot of mass loss factors for Californian avocados that are untreated, coated with monoglyceride coatings, and coated with sorbitan ester coatings.

FIG. 18 shows a plot of respiration rates for Californian avocados that are untreated, coated with monoglyceride coatings, and coated with sorbitan esters.

FIG. 19 shows a plot of mass loss factors for Mexican avocados that are untreated, coated with monoglyceride coatings, and treated with sorbitan esters.

FIG. 20 shows a plot of respiration rates for Mexican avocados that are untreated, coated with monoglyceride coatings, and treated with sorbitan esters.

FIG. 21 shows a plot of mass loss factors for agricultural products that are untreated, coated with monoglyceride coatings, coated with monoglyceride coatings with a wetting agent additive, and treated with monoglyceride coatings with a sorbitan ester additive.

FIG. 22 shows a DSC plot for 95/5 glycerol monostearate/sodium stearate, 25 g/L dispersion.

FIG. 23 shows a DSC plot for 100/0 C₁₈ erythritol ester/sodium stearate, 25 g/L dispersion.

FIG. 24 shows a DSC plot for 95/5 C₁₈ erythritol ester/sodium stearate, 25 g/L dispersion.

FIG. 25 shows a DSC plot for 100/0 C₁₈ xylitol ester/sodium stearate, 25 g/L dispersion.

FIG. 26 shows a DSC plot for a 95/5 C₁₈ xylitol ester/sodium stearate, 25 g/L dispersion.

FIG. 27 shows contact angles for the dispersions of FIGS. 22-26.

### DETAILED DESCRIPTION

### Definitions

As used herein, the term “plant matter” refers to any portion of a plant, including, for example, fruits (in the botanical sense, including fruit peels and juice sacs), vegetables, leaves, stems, barks, seeds, flowers, peels, or roots. Plant matter includes pre-harvest plants or portions thereof as well as post-harvest plants or portions thereof, including, e.g., harvested fruits and vegetables, harvested roots and berries, and picked flowers.

As used herein, a “coating agent” refers to a composition including a compound or group of compounds from which a protective coating can be formed.

As used herein, the “mass loss rate” refers to the rate at which the product loses weight (e.g., by releasing water and other volatile compounds). The mass loss rate is typically expressed as a percentage of the original mass per unit time (e.g., percent per day).

As used herein, the term “mass loss factor” is defined as the ratio of the average mass loss rate of uncoated produce (measured for a control group) to the average mass loss rate of the corresponding tested produce (e.g., coated produce) over a given time. Hence a larger mass loss factor for a coated produce corresponds to a greater reduction in average mass loss rate for the coated produce.

As used herein, the term “respiration rate” refers to the rate at which the product releases gas, such as CO₂. This rate can be determined from the volume of gas (e.g., CO₂) (at standard temperature and pressure) released per unit time per unit weight of the product. The respiration rate can be expressed as ml gas/kg·hour. The respiration rate of the product can be measured by placing the product in a closed container of known volume that is equipped with a sensor, such as a CO₂ sensor, recording the gas concentration within the container as a function of time, and then calculating the rate of gas release required to obtain the measured concentration values.

As used herein, the term “respiration factor” is defined as the ratio of the average gas diffusion (e.g., CO₂ release) of uncoated produce (measured for a control group) to the average gas diffusion of the corresponding tested produce (e.g., coated produce) over a given time. Hence a larger respiration factor for a coated produce corresponds to a greater reduction in gas diffusion / respiration for the coated produce.

As used herein, the term “contact angle” of a liquid on a solid surface refers to an angle of the outer surface of a droplet of the liquid measured where the liquid-vapor interface meets the liquid-solid interface. The contact angle quantifies the wettability of the solid surface by the liquid.

As used herein, the terms “wetting agent” or “surfactant” each refer to a compound that, when added to a solvent, suspension, colloid, or solution, reduces the difference in surface energy between the solvent/suspension/colloid/solution and a solid surface on which the solvent/suspension/colloid/solution is disposed.

As used herein, “lamellar structure” refers to a structure comprising lamella(e) vertically stacked adjacent to each other and held together by intermolecular forces. As used herein, “lamella(e)” refers to one lamella or two or more lamellae, that is, one or more discrete layers of molecules, respectively. In some embodiments, the molecules present in the lamella(e) are ordered (e.g., aligned, as in an open bilayer). The distance between a surface of a lamella and a surface of an adjacent lamella that is facing the same direction is referred to herein as “interlayer spacing” or “periodic spacing”. Interlayer spacing between two lamellae is determined by (1) obtaining an out-of-plane X-ray scattering image of a coating, (2) determining the scattering vector (q) of the peak corresponding to the lamellar structure, and (3) using Bragg’s equation below, determine the interlayer spacing (d).

$$\text{d} = 2 π / \text{qpeak}$$

As used herein, a “lipid bilayer” or “bilayer structure” refers to a structure which includes two contiguous sublayers, wherein each sublayer comprises molecules of sucrose esters or sorbitan esters aligned adjacent to each other lengthwise such that the hydrophilic ends form a hydrophilic surface and the hydrophobic ends form a hydrophobic surface; and the molecular arrangement defines a repeating lattice structure. The hydrophobic surfaces of each sublayer in the lipid bilayer face each other, and the hydrophilic surfaces of each layer face away from each other. A lipid bilayer can be an “open bilayer,” wherein each sublayer is arranged in a parallel sheet. For example, an open bilayer can have a lamellar structure. A lipid bilayer can also be a “closed bilayer,” wherein each sublayer is arranged in a circular structure. For example, a closed bilayer can have a spherical or cylindrical structure.

As used herein, “grain” refers to a domain within a lamellar structure wherein the lattice formation is continuous and has one orientation. The boundaries between the grains in a lamellar structure are defects in the lattice formation wherein the continuity of the lattice formation and/or orientation of the molecules forming the lattice formation are interrupted. The “grain size” of the grains that form a coating is determined by (1) obtaining an in-plane X-ray scattering image of the coating; (2) determining the full width at half maximum (FWHM) of the peak corresponding to the molecules in the coating; and (3) using the Scherrer equation below to calculate the grain size (D).

$$\text{D} = 2 π \text{b} / \text{FWHM}$$

where b is about 0.95 for a 2-dimensional crystal.

Without being bound by any theory, grain size can inversely correlate with grain boundaries. As such, the larger the grain size, the fewer the grain boundaries; and the smaller the grain size, the more grain boundaries there are. It is further understood that the fewer the grain boundaries in a coating, the lower the mass loss rate and/or respiration rate of the coated agricultural product since there are fewer pathways for water and/or gas to pass through the coating.

As used herein, “mosaicity” refers to the probabilities that the orientation of lamellae in a coating deviate from a plane that is substantially parallel with the plane of the substrate (e.g., agricultural product) surface. Deviation of a lamella from a plane that is substantially parallel with the plane of the substrate surface is understood to be a type of crystal defect that increases the permeability of a coating to air and water, thus increasing the mass loss rate and respiration rate when the coating is disposed over an agricultural product.

As used herein, “substrate” refers to an article that a coating is applied to. In some embodiments, the substrate is an agricultural product (e.g., produce), a silicon substrate, or a substrate comprising a polysaccharide (e.g., cellulose).

### Protective Coatings

Described herein are dispersions (e.g., emulsion or colloid) containing a composition (e.g., a coating agent) in a solvent that can be used to form protective coatings over substrates such as plant matter, agricultural products, or food products. The protective coatings can, for example, prevent or reduce water loss and gas diffusion from the substrates, oxidation of the substrates, and/or can shield the substrates from threats such as bacteria, fungi, viruses, and the like. The coatings can also protect the substrates from physical damage (e.g., bruising) and photodamage. Accordingly, the coating agents, dispersions, and the coatings formed thereof can be used to help store agricultural or other food products for extended periods of time without spoiling. In some instances, the coatings and the coating agents from which they are formed can allow for food to be kept fresh in the absence of refrigeration. The coating agents and coatings described herein can also be edible (i.e., the coating agents and coatings can be non-toxic for human consumption). In some particular implementations, the dispersion includes a wetting agent or surfactant that can cause the dispersion to better spread over the entire surface of the substrate during application, thereby improving surface coverage as well as overall performance of the resulting coating. In some particular implementations, the solutions/suspensions/colloids include an emulsifier which improves the solubility of the coating agent in the solvent and/or allows the coating agent to be suspended or dispersed in the solvent. The wetting agent and/or emulsifier can each be a component of the coating agent, or can be separately added to the dispersion. In some embodiments, the coatings include lamellar structures formed on the surface of the substrate (e.g., agricultural product) over which the coating is disposed.

Plant matter (e.g., agricultural products) and other degradable items can be protected against degradation from biotic or abiotic stressors by forming a protective coating over the outer surface of the product. The coating can be formed by adding the constituents of the coating (herein collectively a “coating agent”) to a solvent (e.g., water and/or ethanol) to form a dispersion (e.g., a solution, suspension, or colloid), applying the dispersion to the outer surface of the product to be coated, e.g., by dipping the product in the dispersion or by spraying the dispersion over the surface of the product, and then removing the solvent from the surface of the product, e.g., by allowing the solvent to evaporate, thereby causing the coating to be formed from the coating agent over the surface of the product. The coating agent can be formulated such that the resulting coating provides a barrier to water and/or oxygen transfer, thereby preventing water loss from and/or oxidation of the coated product. The coating agent can additionally or alternatively be formulated such that the resulting coating provides a barrier to CO₂, ethylene and/or other gas transfer.

Coating agents including one or more sucrose or sorbitan esters can both be safe for human consumption and can be used as coating agents to form coatings that are effective at reducing mass loss and oxidation in a variety of produce. For example, coatings formed from coating agents that include various combinations of one or more sucrose esters, such as sucrose stearate, sucrose palmitate, and/or sucrose monolaurate, have been shown to be effective at reducing mass loss rates in many types of produce, for example avocados, tomatoes, and peaches. For example, coatings formed from coating agents that include various combinations of one or more sorbitan esters, such as sorbitan monostearate and/or sorbitan monopalmitate, have been shown to be effective at reducing mass loss rates in many types of produce, for example, avocados. Specific examples of a variety of coatings and their effects in reducing mass loss rates in various types of produce are provided in the Examples below.

Coating compositions can include one or more sorbitan or sucrose esters as wetting agents. For example, coating compositions can include sorbitan monolaurate as a wetting agent.

### Coating and Coating Agent Compositions

In some embodiments, the compositions (e.g., the coating agents or coatings) comprise one or more sucrose or sorbitan esters. In some embodiments, the composition comprises one or more sucrose esters. In some embodiments, the one or more sucrose esters have an ester chain length in the range of C₁₀ to C₂₄. In some embodiments, the one or more sucrose esters have an ester chain length predominantly in the range of C₁₆ to C₁₈. In some embodiments, the one or more sucrose esters are predominantly comprised of sucrose esters having a chain length of C₁₈. In some embodiments, the one or more sucrose esters comprise sucrose stearate, sucrose palmitate, or sucrose laurate. In some embodiments, the one or more sucrose esters comprise sucrose monostearate, sucrose monopalmitate, and/or sucrose monolaurate.

In some embodiments, the composition comprises one or more sorbitan esters. In some embodiments, the one or more sucrose esters have an ester chain length in the range of C₁₀ to C₂₄. In some embodiments, the one or more sorbitan esters comprise sorbitan stearate, sorbitan palmitate, or sorbitan laurate. In some embodiments, the one or more sorbitan esters comprise sorbitan monostearate, sorbitan monopalmitate, and/or sorbitan monolaurate. In some embodiments, the one or more sorbitan esters comprise one or more ethoxylated sorbitan esters. For example, in some embodiments, the one or more sorbitan esters comprise an ethoxylated sorbitan monolaurate.

In some embodiments, the composition (e.g., coating or coating agent) comprises about 90 wt% to about 100 wt% of the one or more sucrose or sorbitan esters. For example, the composition may comprise about 94 wt% to about 100 wt% of the one or more sucrose or sorbitan esters. In some embodiments, the composition (e.g., coating or coating agent) comprises about 100 wt% of the one or more sucrose or sorbitan esters.

In some embodiments, the composition (e.g., coating or coating agent) comprises about 1 wt% to about 15 wt% of the one or more sucrose or sorbitan esters. For example, the composition may comprise about 1 wt% to about 10 wt%, or about 2.5 wt% to about 7.5 wt% of the one or more sucrose or sorbitan esters. In some embodiments, the composition (e.g., coating or coating agent) comprises about 85 wt% to about 99 wt% one or more fatty acid derivatives.

In some embodiments, the composition comprises one or more esters of a monosaccharide. In some embodiments, the one or more esters of a monosaccharide have an ester chain length in a range of C₈ to C₂₄, e.g., C₈ to C₁₆. In some embodiments, the one or more esters of a monosaccharide comprise an ester of an aldose, an ester of a ketose, an ester of a furanose, or an ester of a pyranose. In some embodiments, the one or more esters of a monosaccharide comprise an ester of a diose (e.g., an aldodiose), of a triose (e.g., an aldotriose or a ketotriose), of a tetrose (e.g., an aldotetrose or a ketotetrose), of a pentose (e.g., an aldopentose or a ketopentose), of a hexose (e.g., an aldohexose or a ketohexose), or of a heptose (e.g., an aldoheptose or a ketoheptose). In some embodiments, the one or more esters of a monosaccharide comprise an ester of an aldohexose such as, for example, an ester of allose, an ester of altrose, an ester of glucose, an ester of mannose, an ester of gulose, an ester of idose, an ester of galactose, or an ester of talose. In some embodiments, the one or more esters of a monosaccharide comprise a glucose ester. In some embodiments, the one or more esters of a monosaccharide comprise an ester of a ketohexose such as, for example, an ester of psicose, an ester of fructose, an ester of sorbose, or an ester of tagatose. In some embodiments, the one or more esters of a monosaccharide comprise a mixture of monoesters, diesters, and triesters. In some embodiments, the one or more esters of a monosaccharide are comprised of predominantly monoesters. In some embodiments, the one or more esters of a monosaccharide are comprised of predominantly diesters.

In some embodiments, the composition (e.g., coating or coating agent) comprises about 1 wt% to about 15 wt% of the one or more esters of a monosaccharide. For example, the composition may comprise about 1 wt% to about 10 wt%, or about 2.5 wt% to about 7.5 wt% of the one or more esters of a monosaccharide. In some embodiments, the composition (e.g., coating or coating agent) comprises about 85 wt% to about 99 wt% of one or more fatty acid derivatives.

In some embodiments, the composition comprises one or more esters of a disaccharide. In some embodiments, the composition comprises one or more esters of a reducing disaccharide such as, for example, an ester of sucrose or an ester of trehalose. In some embodiments, the composition comprises one or more esters of a non-reducing disaccharide such as, for example an ester of lactose or an ester of maltose. In some embodiments, the one or more esters of a disaccharide comprise a mixture of monoesters, diesters, and triesters. In some embodiments, the one or more esters of a dinosaccharide are comprised of predominantly monoesters. In some embodiments, the one or more esters of a disaccharide are comprised of predominantly diesters.

In some embodiments, the composition (e.g., coating or coating agent) comprises about 1 wt% to about 15 wt% of the one or more disaccharide esters. For example, the composition may comprise about 1 wt% to about 10 wt%, or about 2.5 wt% to about 7.5 wt% of the one or more disaccharide esters. In some embodiments, the composition (e.g., coating or coating agent) comprises about 85 wt% to about 99 wt% of one or more fatty acid derivatives.

In some embodiments, the one or more esters of a monosaccharide or disaccharide comprise a mixture of monoesters, diesters, and triesters. In some embodiments, the one or more esters of a monosaccharide or disaccharide are comprised of predominantly monoesters. In some embodiments, the one or more esters of a monosaccharide or disaccharide are comprised of predominantly diesters.

In some embodiments, the composition comprises one or more esters of a sugar alcohol. In some embodiments, the one or more esters of a sugar alcohol each have an ester chain length in the range of C₂ to C₁₂. In some embodiments, composition comprises one or more esters of sugar alcohol derived from a monosaccharide, a sugar alcohol derived from a disaccharide, or combinations thereof. In some embodiments, the one or more esters of a sugar alcohol comprise an ester of ethylene glycol, an ester of glycerol, an ester of erythritol, an ester of threitol, an ester of arabitol, an ester of xylitol, an ester of ribitol, an ester of mannitol, an ester of galactitol, an ester of fucitol, an ester of iditol, an ester of inositol, an ester of volemitol, an ester of isomalt, an ester of lactitol, or combinations thereof.

In some embodiments, the composition (e.g., coating or coating agent) comprises about 1 wt% to about 15 wt% of the one or more esters of a sugar alcohol. For example, the composition may comprise about 1 wt% to about 10 wt%, or about 2.5 wt% to about 7.5 wt% of the one or more esters of a sugar alcohol. In some embodiments, the composition (e.g., coating or coating agent) comprises about 85 wt% to about 99 wt% of one or more fatty acid derivatives.

In some embodiments, the composition (e.g., coating or coating agent) does not include a stabilizer or viscosity modifier. For example, the composition may be free of sodium carboxymethylcellulose or other modified or unmodified polysaccharides.

In some embodiments, the compositions (e.g., the coating agents or coatings) further comprise one or more fatty acid derivatives, such as a fatty acid ester or a fatty acid salt. In some embodiments, the one or more fatty acid derivatives comprises one or more monoglycerides. In some embodiments, the compositions further comprise a monoglyceride, a fatty acid salt, or both.

### Coating Agent Mixtures

In some embodiments, the composition (e.g., coating agent) can be dissolved, mixed, dispersed, or suspended in a solvent to form a mixture or dispersion (e.g., solution, suspension, emulsion, or colloid). Examples of solvents that can be used include water, water containing ammonia, water containing amines, water containing bases, methanol, ethanol, isopropanol, butanol, acetone, ethyl acetate, chloroform, acetonitrile, tetrahydrofuran, diethyl ether, methyl tert-butyl ether, or combinations thereof. For example, the solvent can be water. For example, the solvent can be ethanol.

In some embodiments, the concentration of the composition (e.g., coating agent) in the dispersion is about 1 mg/mL to about 200 mg/mL, for example, about 1 to about 150 mg/mL, 1 to 100 mg/mL, about 1 to about 90 mg/mL, about 1 to about 80 mg/mL, about 1 to about 75 mg/mL, about 1 to about 70 mg/mL, about 1 to about 65 mg/mL, about 1 to about 60 mg/mL, about 1 to about 55 mg/mL, about 1 to about 50 mg/mL, about 1 to about 45 mg/mL, about 1 to about 40 mg/mL, about 2 to about 200 mg/mL, about 2 to about 150 mg/mL, about 2 to about 100 mg/mL, about 2 to about 90 mg/mL, about 2 to about 80 mg/mL, about 2 to about 75 mg/mL, about 2 to about 70 mg/mL, about 2 to about 65 mg/mL, about 2 to about 60 mg/mL, about 2 to about 55 mg/mL, about 2 to about 50 mg/mL, about 2 to about 45 mg/mL, about 2 to about 40 mg/mL, about 5 to about 200 mg/mL, about 5 to about 150 mg/mL, about 5 to about 100 mg/mL, about 5 to about 90 mg/mL, about 5 to about 80 mg/mL, about 5 to about 75 mg/mL, about 5 to about 70 mg/mL, about 5 to about 65 mg/mL, about 5 to about 60 mg/mL, about 5 to about 55 mg/mL, about 5 to about 50 mg/mL, about 5 to about 45 mg/mL, about 5 to about 40 mg/mL, about 10 to about 200 mg/mL, about 10 to about 150 mg/mL, about 10 to about 100 mg/mL, about 10 to about 90 mg/mL, about 10 to about 80 mg/mL, about 10 to about 75 mg/mL, about 10 to about 70 mg/mL, about 10 to about 65 mg/mL, about 10 to about 60 mg/mL, about 10 to about 55 mg/mL, about 10 to about 50 mg/mL, about 10 to about 45 mg/mL, about 10 to about 40 mg/mL, about 20 to about 50 mg/mL, about 20 to about 40 mg/mL, about 25 to about 35 mg/mL, about 30 mg/mL to about 125 mg/mL, about 30 to about 50 mg/mL, or about 35 to about 45 mg/mL. For example, the concentration of the composition (e.g., coating agent) in the dispersion can be about 50 mg/mL, or about 30 mg/mL.

In some embodiments, the concentration of the one or more sucrose or sorbitan esters in the dispersion is about 1 mg/mL to about 5 mg/mL, for example, about 1 mg/mL to about 10 mg/mL, or about 1 mg/mL to about 4 mg/mL.

As previously described, coating agents can be formed predominantly of various combinations of sucrose esters or sorbitan esters. Also as previously described, coating agents can be formed predominantly of various combinations of fatty acid derivatives. As also previously described, the coatings can be formed over the outer surface of the agricultural product by dissolving, suspending, or dispersing the coating agent in a solvent to form a dispersion, applying the dispersion to the surface of the agricultural product (e.g., by spray coating the product, by dipping the product in the dispersion, or by brushing the dispersion onto the surface of the product), and then removing the solvent (e.g., by allowing the solvent to evaporate). The solvent can include any polar, non-polar, protic, or aprotic solvents, including any combinations thereof. Examples of solvents that can be used include water, methanol, ethanol, isopropanol, butanol, acetone, ethyl acetate, chloroform, acetonitrile, tetrahydrofuran, diethyl ether, methyl tert-butyl ether, any other suitable solvent or combinations thereof. In cases where the coating is going to be applied to plants or other edible products, it may be preferable to use a solvent that is safe for consumption, for example water, ethanol, or combinations thereof. Depending on the solvent that is used, the solubility limit of the coating agent in the solvent may be lower than desired for particular applications.

In order to improve the solubility of the coating agent in the solvent, or to allow the coating agent to be suspended or dispersed in the solvent, the coating agent can further include an emulsifier. When the coatings are to be formed over plants or other edible products, it may be preferable that the emulsifier be safe for consumption. Furthermore, it is also preferable that the emulsifier either not be incorporated into the coating or, if the emulsifier is incorporated into the coating, that it does not degrade the performance of the coating.

In order to improve the homogeneity of the coating agent in the solvent, the coating agent can further include a salt (e.g., sodium chloride, potassium chloride, sodium bicarbonate, sodium carbonate, potassium bicarbonate, potassium carbonate, etc.).

As described above, the coating agent can be added to or dissolved, suspended, or dispersed in a solvent to form a colloid, suspension, or solution. The various components of the coating agent (e.g., the sucrose ester or sorbitan ester) can be combined prior to being added to the solvent and then added to the solvent together. Alternatively, the components of the coating agent can be kept separate from one another and then be added to the solvent consecutively (or at separate times).

As also described above and demonstrated in the examples below, the coating solutions/suspensions/colloids can further include a wetting agent that serves to reduce the contact angle between the dispersion and the surface of the substrate being coated. The wetting agent can be included as a component of the coating agent and therefore added to the solvent at the same time as other components of the coating agent. Alternatively, the wetting agent can be separate from the coating agent and can be added to the solvent either before, after, or at the same time as the coating agent. Alternatively, the wetting agent can be separate from the coating agent, and can be applied to a surface before the coating agent in order to prime the surface.

In some embodiments, the coating (e.g., solution, suspension, emulsion, colloid) is free of added wetting agent or surfactant.

In some embodiments, the wetting agent is a sucrose ester or a sorbitan ester. For example, the wetting agent can be sucrose monolaurate. For example, the wetting agent can be sorbitan monolaurate.

In some embodiments, the mixture or composition (e.g., coating or coating agent) comprises one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylatedhydroxyanisole (BHA), butylatedhydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzonic acid, sorbic acid, bronidol, and propylene glycol.

Any of the coating solutions/suspensions/colloids described herein can further include an antimicrobial agent, for example ethanol or citric acid. In some embodiments, the antimicrobial agent is part of or a component of the solvent. Any of the coating solutions described herein can further include other components or additives such as salts of bicarbonate and salts of carbonate (e.g., sodium carbonate).

Any of the coating agents described herein can further include additional materials that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antifungals, antimicrobials, and/or time-released drugs. The additional materials can be non-reactive with surface of the coated product and/or coating, or alternatively can be reactive with the surface and/or coating.

In some embodiments, the coating can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO₂, or ethylene through the coating or enable the coating to absorb more ultraviolet (UV) light, for example to protect the agricultural product (or any of the other products described herein). In some embodiments, the additive can be configured to provide an intentional odor, for example a fragrance (e.g., smell of flowers, fruits, plants, freshness, scents, etc.). In some embodiments, the additive can be configured to provide color and can include, for example, a dye or a US Food and Drug Administration (FDA) approved color additive.

Any of the coating agents or coatings formed thereof that are described herein can be flavorless or have high flavor thresholds, e.g., above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

Any of the coatings described herein can be disposed on the external surface of an agricultural product or other substrate using any suitable means. For example, the substrate can be dip-coated in a bath of the coating formulation (e.g., an aqueous or mixed aqueous-organic or organic solution). The deposited coating can form a thin layer on the surface of an agricultural product, which can protect the agricultural product from biotic stressors, water loss, respiration, and/or oxidation. In some embodiments, the deposited coating can have a thickness of less than about 20 microns, 10 microns, 9 microns, 8 microns, 7 microns, 6 microns, 5 microns, 4 microns, 3 microns, 2 microns, or 1.5 microns. In some embodiments, the deposited coating can have a thickness of about 100 nm to about 20 microns, about 100 nm to about 2 microns, about 700 nm to about 1.5 microns, about 700 nm to about 1 micron, about 1 micron to about 1.6 microns, about 1.2 microns to about 1.5 microns. In some embodiments, the coating is transparent to the naked eye. In some embodiments, the deposited coating has a thickness of about 10 nm, 20 nm, 30 nm, 40 nm, 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1,000 nm, 1,100 nm, 1,200 nm, 1,300 nm, 1,350 nm, 1,400 nm, 1,500 nm, 1,600 nm, 1,700 nm, 1,800 nm, 1,900 nm, 2,000 nm, 2,100 nm, 2,200 nm, 2,300 nm, 2,400 nm, 2,500 nm, 2,600 nm, 2,700 nm, 2,800 nm, 2,900 nm, or 3,000 nm, inclusive of all ranges therebetween.

In some embodiments, the deposited coating can be deposited substantially uniformly over the substrate and can be free of defects and/or pinholes. In some embodiments, the dip-coating process can include sequential coating of the agricultural product in baths of coating precursors that can undergo self-assembly or covalent bonding on the agricultural product to form the coating. In some embodiments, the coating can be deposited on agricultural products by passing the agricultural products under a stream of the coating (e.g., a waterfall of the dispersion). For example, the agricultural products can be disposed on a conveyor that passes through the stream of the coating. In some embodiments, the coating can be misted, vapor- or dry vapor-deposited on the surface of the agricultural product. In some embodiments, the coating can be mechanically applied to the surface of the product to be coated, for example by brushing it onto the surface. In some embodiments, the coating can be configured to be fixed on the surface of the agricultural product by UV crosslinking or by exposure to a reactive gas, for example oxygen.

In some embodiments, the coating solutions/suspensions/colloids can be spray-coated on the agricultural products. Commercially available sprayers can be used for spraying the coating solutions/suspensions/colloids onto the agricultural product. In some embodiments, the coating formulation can be electrically charged in the sprayer before spray-coating on to the agricultural product, such that the deposited coating electrostatically and/or covalently bonds to the exterior surface of the agricultural product.

In some embodiments, coatings formed from coating agents described herein over agricultural products can be configured to change the surface energy of the agricultural product. Various properties of coatings described herein can be adjusted by tuning the crosslink density of the coating, its thickness, or its chemical composition. This can, for example, be used to control the ripening of postharvest fruit or produce. For example, coatings formed from coating agents that primarily include bifunctional or polyfunctional monomer units can, for example, have higher crosslink densities than those that include monofunctional monomer units. Thus, coatings formed from bifunctional or polyfunctional monomer units can in some cases result in slower rates of ripening as compared to coatings formed from monofunctional monomer units.

In some embodiments, one or more wetting agents such as those described above are used to improve the wetting of the surfaces to which the coating dispersions are applied, but the wetting agent are not included in the coating dispersions. Instead, the wetting agents are added to a second solvent (which can be the same as or different than the solvent to which the coating agent is added) to form a second mixture, and the second mixture is applied to the surface to be coated prior to applying the coating to the surface. In this case, the second mixture can prime the surface to be coated such that the contact angle of the coating with the surface is less than it would have otherwise been, thereby improving surface wetting.

As previously described, the coatings formed from coating agents described herein can be configured to prevent water loss or other moisture loss from the coated portion of the plant, delay ripening, and/or prevent oxygen diffusion into the coated portion of the plant, for example, to reduce oxidation of the coated portion of the plant. The coatings can also serve as a barrier to diffusion of carbon dioxide and/or ethylene into or out of the plant or agricultural product. The coatings can also protect the coated portion of the plant against biotic stressors, such as, for example, bacteria, fungi, viruses, and/or pests that can infest and decompose the coated portion of the plant. Since bacteria, fungi and pests all identify food sources via recognition of specific molecules on the surface of the agricultural product, coating the agricultural products with the coating agent can deposit molecularly contrasting molecules on the surface of the portion of the plant, which can render the agricultural products unrecognizable. Furthermore, the coating can also alter the physical and/or chemical environment of the surface of the agricultural product making the surface unfavorable for bacteria, fungi or pests to grow. The coating can also be formulated to protect the surface of the portion of the plant from abrasion, bruising, or otherwise mechanical damage, and/or protect the portion of the plant from photodegradation. The portion of the plant can include, for example, a leaf, a stem, a shoot, a flower, a fruit, a root, etc.

Any of the coatings described herein can be used to reduce the humidity generated by agricultural products (e.g., fresh produce) via mass loss (e.g., water loss) during transportation and storage by reducing the mass loss rate of the agricultural products (e.g., fresh produce).

In some embodiments, the agricultural product is coated with a composition that reduces the mass loss rate by at least about 10%, 15%, 20%, 25%, 30%, 35%, 40%, 45%, 50%, 55%, 60%, 65%, 70%, 75%, 80%, 85%, 90% or greater compared to untreated product measured. In some embodiments, treating an agricultural product using any of the coatings described herein can give a mass loss factor of at least about 1.1, 1.2, 1.3, 1.4, 1.5, 1.6, 1.7, 1.8, 1.9, 2.0, 2.2, 2.4, 2.6, 2.8, or 3.0. In some embodiments, treating an agricultural product using any of the coatings described herein can reduce the humidity generated during storage by at least about 1%, 2%, 3%, 4%, 5%, 10%, 15%, 20%, 25%, 30%, 35%, 40%, 45%, 50%, 55%, 60%, 65%, 70%, 75%, 80%, 85%, 90% or greater compared to untreated product. In some embodiments, the reduction in mass loss rate of the agricultural product can reduce the energy required to maintain a relative humidity at a predetermined level (e.g., at about 90%, 85%, 80%, 75%, 70%, 65%, 60%, 55%, 50%, or 45% relative humidity or less) during storage or transportation. In some embodiments, the energy required to maintain a relative humidity at the predetermined level (e.g., any of the predetermined levels listed above) during storage or transportation can be reduced by at least about 1%, 2%, 3%, 4%, 5%, 10%, 15%, 20%, 25%, 30%, 35%, 40%, 45%, 50%, 55%, 60%, 65%, 70%, 75%, 80%, 85%, 90% or greater compared to untreated product.

Any of the coatings described herein can be used to reduce the heat generated by agricultural products (e.g., fresh produce) via respiration during transportation and storage by reducing the respiration rate of the agricultural products (e.g., fresh produce). In some embodiments, the product is coated with a composition that reduces the respiration rate by at least about 10%, 15%, 20%, 25%, 30%, 35%, 40%, 45%, 50%, 55%, 60%, 65%, 70%, 75%, 80%, 85%, 90% or greater compared to untreated product (measured as described above). In some embodiments, the reduction in heat generated by the agricultural product can reduce the energy required to maintain a temperature (e.g., a predetermined temperature) during storage or transportation. In some embodiments, the heat generated can be reduced by at least about 5%, 10%, 15%, 20%, 25%, 30%, 35%, 40%, 45%, 50%, 55%, 60%, 65%, 70%, 75%, 80%, 85%, 90% or greater for coated products compared to untreated products. In some embodiments, the energy required to maintain the coated products at a predetermined temperature (e.g., about 25° C., 23° C., 20° C., 18° C., 15° C., 13° C., 10° C., 8° C., 5° C., or 3° C. or less) can be reduced by at least about 1%, 2%, 3%, 4%, 5%, 10%, 15%, 20%, 25%, 30%, 35%, 40%, 45%, 50%, 55%, 60%, 65%, 70%, 75%, 80%, 85%, 90% or greater compared to untreated products.

Respiration rate approximations for various types of agricultural products (e.g., fresh produce) are shown in Table 1.

Table 1

Respiration rates for various agricultural products

| Produce Type | Respiration Rate at 20° C. (ml CO₂/(kg·hour)) |
|---|---|
| Apples | 10-30 |
| Apricot | 15-25 |
| Asparagus | 138-250 |
| Avocado | 40-150 |
| Bananas | 20-70 |
| Broccoli | 140-160 |
| Cantaloupe | 23-33 |
| Cherry | 22-28 |
| Corn | 268-311 |
| Cucumber | 7-24 |
| Fig | 20-30 |
| Grape | 12-15 |
| Grapefruit | 7-12 |
| Honeydew | 20-27 |
| Kiwifruit | 15-20 |
| Lemon | 10-14 |
| Lime | 6-10 |
| Mandarin | 10-15 |
| Mango | 35-80 |
| Orange | 11-17 |
| Papaya | 15-35 (at 15° C.) |
| Peach | 32-55 |
| Pear | 15-35 |
| Peas | 123-180 |
| Pineapple | 15-20 |
| Strawberry | 50-100 |
| Tomato | 12-22 |
| Watermelon | 17-25 |

In some embodiments, the methods and compositions described herein are used to treat agricultural products (e.g., fresh produce) that are stored and/or transported in a refrigerated container or “reefer”. Heat from produce respiration is a contributor to the overall heat within a refrigerated container. In some embodiments, the methods and compositions described herein can reduce the respiration rate of the treated agricultural products (e.g., fresh produce) in order to reduce the heat generated due to respiration of the agricultural products (e.g., fresh produce) in a refrigerated container or “reefer”. In some embodiments, the methods and compositions described herein can reduce the mass loss rate of the treated agricultural products (e.g., fresh produce) in order to reduce the humidity generated due to mass loss (e.g., water loss) of the agricultural products (e.g., fresh produce) in a refrigerated container or “reefer”.

The methods and compositions described herein can also be used to minimize or reduce temperature or humidity gradients that arise from concentrating agricultural products (e.g., fresh produce) in stacks or pallets in order to prevent uneven ripening. The treated agricultural products (e.g., fresh produce) can be straight stacked during storage or can be stacked in an alternative fashion (e.g., cross stacked) to increase circulation around the agricultural products (e.g., fresh produce). Within the produce supply chain, boxes of agricultural products may be reoriented from a straight stack, which can be preferable during shipment, to a cross stack, which can be used during storage to increase air circulation and to prevent uneven ripening.

In some embodiments, treating an agricultural product with a coating that reduces the respiration rate can reduce the rate at which the temperature increases in a stack (e.g., upon removal from cold storage) by at least about 0.5° C. per day, for example, at least about 1.0° C., 1.5° C., 2.0° C., 2.5° C., 3.0° C., 3.5° C., 4.0° C., 4.5° C., or 5° C. per day, as compared to an untreated stack. In some embodiments, treating an agricultural product with a coating that reduces the respiration rate can reduce the equilibrium temperature difference between the atmosphere and the average temperature of the stack by at least about 0.5° C., 1.0° C., 1.5° C., 2.0° C., 2.5° C., 3.0° C., 3.5° C., 4.0° C., 4.5° C., or 5° C.

Any of the coatings described herein can be used to protect any agricultural product. In some embodiments, the coating can be coated on an edible agricultural product, for example, fruits, vegetables, edible seeds and nuts, herbs, spices, produce, meat, eggs, dairy products, seafood, grains, or any other consumable item. In such embodiments, the coating can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located at “www.accessdata.fda.gov/scripts/cdrh/cfdocs/cfcfr/cfrsearch.cfm”. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be flavorless or have a high flavor threshold of below 500 ppm, are odorless or have a high odor threshold, and/or are substantially transparent. In some embodiments, the coating can be configured to be washed off an edible agricultural product, for example, with water.

In some embodiments, the coatings described herein can be formed on an inedible agricultural product. Such inedible agricultural products can include, for example, inedible flowers, seeds, shoots, stems, leaves, whole plants, and the like. In such embodiments, the coating can include components that are non-toxic, but the threshold level for non-toxicity can be higher than that prescribed for edible products. In such embodiments, the coating can include an FDA approved food contact substance, an FDA approved food additive, or an FDA approved drug ingredient, for example, any ingredient included in the FDA’s database of approved drugs, which can be found at “http://www.accessdata.fda.gov/scripts/cder/drugsatfda/index.cfm”. In some embodiments, the coating can include materials that satisfy FDA requirements to be used in drugs or are listed within the FDA’s National Drug Discovery Code Directory, “www.accessdata.fda.gov/scripts/cder/ndc/default.cfm”. In some embodiments, the materials can include inactive drug ingredients of an approved drug product as listed within the FDA’s database, “www.accessdata.fda.gov/scripts/cder/ndc/default.cfm”.

Embodiments of the coatings described herein provide several advantages, including, for example: (1) the coatings can protect the agricultural products from biotic stressors, i.e. bacteria, viruses, fungi, or pests; (2) the coatings can prevent evaporation of water and/or diffusion of oxygen, carbon dioxide, and/or ethylene; (3) coating can help extend the shelf life of agricultural products, for example, post-harvest produce, without refrigeration; (4) the coatings can introduce mechanical stability to the surface of the agricultural products eliminating the need for expensive packaging designed to prevent the types of bruising which accelerate spoilage; (5) use of agricultural waste materials to obtain the coatings can help eliminate the breeding environments of bacteria, fungi, and pests; (6) the coatings can be used in place of pesticides to protect plants, thereby minimizing the harmful impact of pesticides to human health and the environment; (7) the coatings can be naturally derived and hence, safe for human consumption. Since in some cases the components of the coatings described herein can be obtained from agricultural waste, such coatings can be made at a relatively low cost. Therefore, the coatings can be particularly suited for small scale farmers, for example, by reducing the cost required to protect crops from pesticides and reducing post-harvest losses of agricultural products due to decomposition by biotic and/or environmental stressors.

Due to segmentation in the marketplace, the preparation/formation of coating agents or coating solutions/suspensions/colloids and the formation of coatings over substrates from the coating solutions/suspensions/colloids are often carried out by different parties or entities. For example, a manufacturer of compositions such as coating agents described herein (i.e., a first party) can form the compositions by one or more of the methods described herein. The manufacturer can then sell or otherwise provide the resulting composition to a second party, for example a farmer, shipper, distributor, or retailer of produce, and the second party can apply the composition to one or more agricultural products to form a protective coating over the products. Alternatively, the manufacturer can sell or otherwise provide the resulting composition to an intermediary party, for example a wholesaler, who then sells or otherwise provides the composition to a second party such as a farmer, shipper, distributor, or retailer of produce, and the second party can apply the composition to one or more agricultural products to form a protective coating over the products.

In some cases where multiple parties are involved, the first party may optionally provide instructions or recommendations about the composition (i.e., the coating agent), either written or oral, indicating one or more of the following: (i) that the composition is intended to be applied to a product for the purpose of coating or protecting the product, to extend the life of the product, to reduce spoilage of the product, or to modify or improve the aesthetic appearance of the product; (ii) conditions and/or methods that are suitable for applying the compositions to the surfaces of products; and/or (iii) potential benefits (e.g., extended shelf life, reduced rate of mass loss, reduced rate of molding and/or spoilage, etc.) that can result from the application of the composition to a product. While the instructions or recommendations may be supplied by the first party directly with the plant extract composition (e.g., on packaging in which the composition is sold or distributed), the instructions or recommendations may alternatively be supplied separately, for example on a website owned or controlled by the first party, or in advertising or marketing material provided by or on behalf of the first party.

In view of the above, it is recognized that in some cases, a party that manufactures compositions (i.e., coating agents) or coating solutions/suspensions/colloids according to one or more methods described herein (i.e., a first party) may not directly form a coating over a product from the composition, but can instead direct (e.g., can instruct or request) a second party to form a coating over a product from the composition. That is, even if the first party does not coat a product by the methods and compositions described herein, the first party may still cause the coating agent or solution to be applied to the product to form a protective coating over the product by providing instructions or recommendations as described above. Accordingly, as used herein, the act of applying a coating agent or dispersion to a product (e.g., a plant or agricultural product) also includes directing or instructing another party to apply the coating agent or solution to the product, thereby causing the coating agent or solution to be applied to the product.

### Solvents

The solvent to which the coating agent and wetting agent (when separate from the coating agent) is added to form the dispersion can, for example, be water, methanol, ethanol, isopropanol, butanol, acetone, ethyl acetate, chloroform, acetonitrile, tetrahydrofuran, diethyl ether, methyl tert-butyl ether, an alcohol, any other suitable solvent, or a combination thereof. The resulting solutions, suspensions, or colloids can be suitable for forming coatings on agricultural products. For example, the solutions, suspensions, or colloids can be applied to the surface of the agricultural product, after which the solvent can be removed (e.g., by evaporation or convective drying), leaving a protective coating formed from the coating agent on the surface of the agricultural product.

While a number of the solvents above (particularly water and ethanol) can be safely and effectively used in solutions/suspensions/colloids that are applied to edible products such as produce or other agricultural products, in many cases it can be advantageous to use either water or otherwise a solvent which is at least about 40% (and in many cases higher) water by volume. This is because water is typically cheaper than other suitable solvents and can also be safer to work with than solvents that have a higher volatility and/or a lower flash point (e.g., acetone or alcohols such as isopropanol or ethanol). In some embodiments, the solvent comprises water. For example, the solvent can be water. Accordingly, for any of the dispersions described herein, the solvent can be at least about 40%, 45%, 50%, 55%, 60%, 65%, 70%, 75%, 80%, 85%, 90%, 95%, or 99% water by weight or by volume. In some embodiments, the solvent includes a combination of water and ethanol, and can optionally be at least about 40%, 45%, 50%, 55%, 60%, 65%, 70%, 75%, 80%, 85%, 90%, 95%, or 99% water by volume. In some embodiments, the solvent can be about 40% to 100%, about 40% to about 99%, about 40% to about 95%, about 40% to about 90%, about 40% to about 85%, about 40% to about 80%, about 50% to about 100%, about 50% to about 99%, about 50% to about 95%, about 50% to about 90%, about 50% to about 85%, about 50% to about 80%, about 60% to about 100%, about 60% to about 99%, about 60% to about 95%, about 60% to about 90%, about 60% to about 85%, about 60% to about 80%, about 70% to about 100%, about 70% to about 99%, about 70% to about 95%, about 70% to about 90%, about 70% to about 85%, about 80% to about 100%, about 80% to about 99%, about 80% to about 97%, about 80% to about 95%, about 80% to about 93%, about 80% to about 90%, about 85% to about 100%, about 85% to about 99%, about 85% to about 97%, about 85% to about 95%, about 90% to about 100%, about 90% to about 99%, about 90% to about 98%, or about 90% to about 97% water by weight or volume.

In view of the above, for some applications the solvent can be a low wetting solvent (i.e., a solvent exhibiting a large contact angle with respect to the surface to which it is applied). For example, in the absence of any added wetting agents or other surfactants, the contact angle between the solvent and either (a) carnauba wax, (b) candelilla wax, (c) paraffin wax, or (d) the surface of a non-waxed lemon can be at least about 70°, for example at least about 75°, 80°, 85°, or 90°. Addition of any of the wetting agents described herein to the solvent, either alone or in combination with other compounds or coating agents, can cause the contact angle between the resulting dispersion and either (a) carnauba wax, (b) candelilla wax, (c) paraffin wax, or (d) the surface of a non-waxed lemon to be less than about 85°, for example less than about 80°, 75°, 70°, 65°, 60°, 55°, 50°, 45°, 40°, 35°, 30°, 25°, 20°, 15°, 10°, 5°, or 0°.

The coating agent that is added to or dissolved, suspended, or dispersed in the solvent to form the dispersion can be any compound or combination of compounds capable of forming a protective coating over the substrate to which the dispersion is applied. The coating agent can be formulated such that the resulting coating protects the substrate from biotic and/or abiotic stressors. For example, the coating can prevent or suppress the transfer of oxygen and/or water, thereby preventing the substrate from oxidizing and/or from losing water via transpiration/osmosis/evaporation. In cases where the substrate is perishable and/or edible, for example when the substrate is a plant, an agricultural product, or a piece of produce, the coating agent is preferably composed of non-toxic compounds that are safe for consumption. For example, the coating agent can include fatty acids and/or salts or esters thereof. The fatty acid esters can, for example, be ethyl esters, methyl esters, or glyceryl esters (e.g., 1-glyceryl or 2-glyceryl esters).

In some embodiments, the composition is prepared by dissolving, suspending, or dispersing the coating agent in the solvent at room temperature (e.g., between 20° C. and 30° C.). In some embodiments, the composition is prepared by mixing the coating agent in the solvent at a temperature of between 50° C. to 100° C., such as about 60° C. or about 80° C. In some embodiments, the composition is prepared by mixing one or more sucrose esters in water at room temperature. In some embodiments, the compositions prepared by mixing at room temperature were found to provide higher moisture retention, reduction in respiration, and higher gloss as detailed in Examples below.

### Coated Agricultural Products and Methods of Preparation and Use

In some embodiments, when the components of the coating agent (e.g., sorbitan esters or sucrose esters) are mixed with a solvent, they form microstructures, such as, for example, vesicles in the solvent. In some embodiments, when this mixture contacts a surface, such as an agricultural product (e.g., produce), the microstructure can adsorb to the surface and form an open bilayer (e.g., lamella), or a series of stacked open bilayers to form an open bilayer structure (e.g., a lamellar structure) on the surface. In some embodiments, upon removal or drying of the solvent, the open bilayer structure partitions into grains, the boundaries between the grains being crystal defects. In some embodiments, when this mixture contacts a surface, such as an agricultural product (.e.g., produce), the microstructure can adsorb to the surface and form a closed bilayer (e.g., a sphere or a cylinder), or a series of closed bilayers to form a closed bilayer structure on the surface (e.g., a spherical or cylindrical structure). In some embodiments, upon removal or drying of the solvent, the closed bilayer structure partitions into grains, the boundaries between the grains being crystal defects.

In some embodiments, an advantage of the open bilayer (e.g., a lamellar) structure is its low permeability. Without being bound by any theory, when water passes through the coating, it travels through grain boundaries and between the open bilayer structure if the outer surfaces of the open bilayer structure are sufficiently hydrophilic (e.g., when the lamellae are lipid bilayers). In some embodiments, the open bilayer structure composed of lipid bilayers formed from sorbitan esters or sucrose esters in the coating increases the hydrophilicity of the outer surfaces of the lipid bilayers that make up the coating, thus allowing more water to intercalate between the lipid bilayers and therefore increasing the water permeability of the coating, resulting in an increased mass loss rate.

In some embodiments, an advantage of the closed bilayer structure (e.g., a spherical or cylindrical structure) is its low permeability. Without being bound by any theory, when water passes through the coating, it travels through grain boundaries and between the closed bilayer structure if the outer surfaces of the closed bilayer structure are sufficiently hydrophilic (e.g., when the spherical or cylindrical structures are lipid bilayers). In some embodiments, the closed bilayer structure composed of lipid bilayers formed from sorbitan esters or sucrose esters in the coating increases the hydrophilicity of the outer surfaces of the lipid bilayers that make up the coating, thus allowing more water to intercalate between the lipid bilayers and therefore increasing the water permeability of the coating, resulting in an increased mass loss rate.

In some embodiments, increasing the concentration of the coating agent in the mixture increases the thickness of the coating, which, for example, can reduce the water permeability (and can therefore reduce mass loss when the coating is disposed over an agricultural product) and can lower the gas diffusion ratio (and can therefore reduce the respiration rate when the coating is disposed over an agricultural product).

In some embodiments, the higher the temperature of drying, the larger the grain size and lower the mosaicity (which is a measure of the probabilities that the orientation of crystal planes in a coating deviate from a plane that is substantially parallel with the plane of the substrate surface, recognized as a type of crystal defect) in the coating, which can result in fewer grain boundaries and defects for water and/or gas to travel through. In some embodiments, this can result in a lower water and gas permeability that can translate into a lower mass loss rate and lower respiration rate when, e.g., the coating is disposed on an agricultural product.

In some embodiments, heating the coating (or coated agricultural product) from a first temperature to a second temperature higher than the first temperature but below the melting point (i.e., the phase transition temperature) of the coating, then cooling the coating, can increase the grain size in the coating, which can result in a lower mass loss rate, lower gas diffusion ratio, and lower respiration rate.

### Coated Agricultural Products

In one aspect, described herein is a coated substrate comprising a substrate and a coating comprising a bilayer structure formed on the substrate, wherein the coating has a thickness of less than about 20 microns, for example less than about 10 microns, 5 microns, or 2 microns.

In some embodiments, the layer comprises one or more open bilayers. For example, the open bilayer can be lamellar.

In some embodiments, the layer comprises one or more closed bilayers. For example, the one or more closed bilayers can each independently be cylindrical or spherical.

In another aspect, described herein is a coated substrate comprising a substrate and a coating comprising a lamellar structure formed on the substrate, wherein the coating comprises a plurality of grains. In another aspect, described herein is a coated substrate comprising a substrate and a coating comprising a spherical structure formed on the substrate, wherein the coating comprises a plurality of grains. In another aspect, described herein is a coated substrate comprising a substrate and a coating comprising a cylindrical structure formed on the substrate, wherein the coating comprises a plurality of grains.

In some embodiments, the substrate is an agricultural product, a silicon substrate, a polystyrene substrate, or a substrate comprising a polysaccharide (e.g., cellulose). For example, the substrate can be an agricultural product.

In another aspect, described herein is a coated agricultural product comprising an agricultural product and a coating comprising a lamellar structure formed on the agricultural product, wherein the coating has a thickness of less than about 20 microns.

In another aspect, described herein is a coated agricultural product comprising an agricultural product and a coating comprising a lamellar structure formed on the agricultural product, wherein the coating comprises a plurality of grains.

In some embodiments (e.g., when the lamella is a lipid bilayer, such as a lipid bilayer comprising one or more sorbitan esters or sucrose esters), the lattice formation is defined by a hexagonal unit cell. The distance (referred to as “a”) between each adjacent molecule in the unit cell is about 0.2 nm to about 2 nm, for example, about 0.2 to about 0.7 nm, about 0.2 to about 1.2 nm, about 0.2 nm to about 0.4 nm, about 0.3 nm to about 0.5 nm, about 0.4 nm to about 0.6 nm, about 0.43 nm to about 0.5 nm, or about 0.47 nm to about 0.48 nm. In some embodiments, the lattice formation is defined by an orthorhombic unit cell. In some embodiments, the lattice formation is defined by a tetragonal unit cell. In some embodiments, the lattice formation is defined by a monoclinic unit cell.

In some embodiments, the lamellar structure comprises a plurality of lamellae. The distance between a surface of a lamella and the surface of an adjacent lamella that is facing the same direction is referred to herein as “periodic spacing.” In some embodiments, the interlayer spacing of the lamellae is about 1.0 to about 20 nm, for example, about 1 to about 20 nm, about 2 to about 13 nm, about 3 nm to about 10 nm, about 3 to about 7 nm, about 3 to about 6 nm, about 3 to about 5 nm, about 5 to about 7 nm, about 4 to about 6 nm, about 4 to about 5 nm, about 5 to about 6 nm, or about 5.0 to about 5.8 nm.

In some embodiments, the coating comprises a plurality of grains.

In some embodiments, the grain size is about 2 nm to about 100 nm, for example, about 4 nm to about 100 nm, about 7 nm to about 100 nm, about 6 nm to about 100 nm, about 6 nm to about 80 nm, about 6 nm to about 60 nm, about 6 nm to about 40 nm, about 6 nm to about 25 nm, about 9 nm to about 22 nm, about 9 nm to about 15 nm, about 13 nm to about 25 nm, about 8 nm to about 25 nm, about 11 nm to about 17 nm, about 11 nm to about 14 nm, about 13 nm to about 17 nm, about 12 nm to about 16 nm, about 15 nm to about 17 nm, about 9 nm to about 13 nm, about 13 nm to about 17 nm, about 17 nm to about 25 nm, about 2 nm to about 10 nm, 5 nm to about 10 nm, about 8 nm to about 9 nm, about 8.5 nm to about 9.5 nm, about 9 nm to about 10 nm, or about 8 nm, 9 nm, 10 nm, 11 nm, 12 nm, 13 nm, 14 nm, 15 nm, 16 nm, 17 nm, 19 nm, 21 nm, or 22 nm.

### Methods of Use and Application

In one aspect, described herein is a method of coating a substrate, the method comprising:
applying a dispersion comprising:
   one or more fatty acid esters; and
   one or more sucrose esters, one or more sorbitan esters, or one or more sucrose esters and one or more sorbitan esters;
to a surface of an agricultural product; and
drying the dispersion on the surface of an agricultural product under a flow of air to form a coating on the surface of the agricultural product, wherein:
   the coating comprises a multiplicity of lipid bilayers on the surface of the agricultural product; and
   a thickness of the coating is about 2 microns or less.

In some embodiments, the coating comprises the one or more fatty acid esters and the one or more sucrose esters, the one or more sorbitan esters, or the one or more sucrose esters and one or more sorbitan esters.

In another aspect, described herein is a method of coating a substrate, the method comprising:
applying a dispersion comprising:
   one or more fatty acid esters; and
   one or more sucrose esters, one or more sorbitan esters, one or more monosaccharide esters, one or more disaccharide esters, one or more esters of a sugar alcohol, or any combination thereof;
to a surface of an agricultural product; and
drying the dispersion on the surface of an agricultural product under a flow of air to form a coating on the surface of the agricultural product.

In some embodiments, the coating comprises the one or more fatty acid esters and the one or more sucrose esters, the one or more sorbitan esters, the one or more monosaccharide esters, the one or more disaccharide esters, the one more esters of a sugar alcohol, or any combination thereof.

In some embodiments, the coating comprises a multiplicity of lipid bilayers on the surface of the agricultural product. In some embodiments, a thickness of the coating is about 2 microns or less. In some embodiments, the substrate comprises an agricultural product. In some embodiments, the one or more fatty acid esters comprises one or more monoglycerides.

In some embodiments, the dispersion includes one or more sorbitan esters. In some embodiments, one or more of the sorbitan esters has an ester chain length of C₁₀ to C₂₄. In some embodiments, the one or more sorbitan esters comprises sorbitan monolaurate. In some embodiments, the one or more sorbitan esters comprises one or more ethoxylated sorbitan esters, e.g., ethoxylated sorbitan monolaurate. In some embodiments, a total concentration of the one or more sorbitan esters in the dispersion is between about 1 mg/mL and about 5 mg/mL.

In some embodiments, the dispersion includes one or more monosaccharide esters. In some embodiments, the one or more monosaccharide esters comprises a glucose ester. In some embodiments, one or more of the monosaccharide esters has an ester chain length of C₈ to C₂₄, e.g., C₈ to C₁₆. In some embodiments, a total concentration of the one or more monosaccharide esters in the dispersion is between about 1 mg/mL and about 5 mg/mL.

In some embodiments, the dispersion includes one or more esters of a sugar alcohol. In some embodiments, the one or more esters of a sugar alcohol comprises erythritol etser, xylitol ester, or both. In some embodiments, one or more of the esters of a sugar alcohol has an ester chain length of C₂ to C₁₂. In some embodiments, a concentration of the one or more monsaccharide esters in the dispersion is between about 1 mg/mL and about 5 mg/mL.

In another aspect, described herein is a method of coating a substrate, the method comprising:
applying a dispersion comprising:
   one or more sucrose esters;
   one or more sorbitan esters; or
   one or more sucrose esters and one or more sorbitan esters to a surface of an agricultural product; and
drying the dispersion on the surface of an agricultural product under a flow of air to yield a coating on the agricultural product, wherein the coating comprises:
   a layer comprising the one or more sucrose esters;
   a layer comprising the one or more sorbitan esters; or
   a layer comprising the one or more sucrose esters and the one or more sorbitan esters
on the surface of the agricultural product wherein:
a temperature of the air is greater than about 50° C.,
the coating comprises a multiplicity of bilayers on the surface of the agricultural product, and
each bilayer of the multiplicity of bilayers comprises a multiplicity of grains.

In some embodiments, the temperature of the dispersion is between about 10° C. and about 80° C., for example, between about 10° C. and about 70° C., about 20° C. and about 80° C., about 20° C. and about 60° C., or about 40° C. and about 70° C.

In some embodiments, the temperature of the air is between about 20° C. and about 120° C., for example, between about 20° C. and about 100° C., about 40° C. and about 120° C., or about 50° C. and about 100° C.

In another aspect, described herein is a method of coating a substrate, the method comprising:
applying a dispersion comprising a coating agent and a solvent to the substrate, wherein a temperature of the dispersion is about 50° C. or less;
removing the solvent to yield a coating on the substrate;
heating the coating from a first temperature to a second temperature, wherein the second temperature is greater than the first temperature and less than the melting point of the coating agent, and
cooling the coating from the second temperature to a third temperature, wherein the third temperature is less than the second temperature and the coating comprises multiplicity of bilayers on the surface of the substrate, and
each bilayer of the multiplicity of bilayers comprises a multiplicity of grains.

In another aspect, described herein is a method of coating an agricultural product, the method comprising:
applying a dispersion comprising a coating agent and a solvent to the agricultural product to yield a liquid layer on the agricultural product; and
drying the liquid layer at a temperature between about 50° C. and about 100° C. to yield a coating on the agricultural product,
wherein the coating comprises a multiplicity of bilayers on the surface of the substrate, and
a thickness of the coating is about 2 microns or less.

In another aspect, described herein is a method of coating an agricultural product, the method comprising:
applying a dispersion comprising a coating agent and a solvent to the agricultural product; and
drying the dispersion at a temperature between about 50° C. and about 100° C. to yield a coating on the agricultural product,
wherein the coating comprises a multiplicity of bilayers on the surface of the substrate, and each bilayer of the multiplicity of bilayers comprises a multiplicity of grains.

In another aspect, described herein is a method of coating an agricultural product, the method comprising:
applying a dispersion comprising a coating agent and a solvent to the agricultural product;
removing the solvent to yield a coating on the agricultural product;
heating the coating from a first temperature to a second temperature, wherein the second temperature is greater than the first temperature and less than the melting point of the coating agent; and
cooling the coating from the second temperature to a third temperature, wherein the third temperature is less than the second temperature,
wherein the coating forms a multiplicity of bilayers on the surface of the substrate, and each bilayer of the multiplicity of bilayers comprises a multiplicity of grains.

In some embodiments, the first temperature is about 0° C. to about 50° C., for example, about 10° C. to about 40° C., about 20° C. to about 30° C., about 23° C. to about 27° C., or about 25° C. In some embodiments, the first temperature is greater than the temperature of the surrounding atmosphere. In some embodiments, the first temperature is less than the temperature of the surrounding atmosphere.

In some embodiments, the second temperature is about 40° C. to about 65° C., for example, about 45° C. to about 65° C., about 50° C. to about 65° C., about 55° C. to about 65° C., about 57° C. to about 63° C., or about 60° C. In some embodiments, the second temperature is greater than the temperature of the surrounding atmosphere. In some embodiments, the second temperature is less than the temperature of the surrounding atmosphere. In some embodiments, the coating is heated with air having a temperature higher than the temperature of the agricultural product. In some embodiments, the air that the coating is heated with is higher than the second temperature. In some embodiments, the air that the coating is heated with is higher than the melting point of the coating.

In some embodiments, if the coating is heated at or above a melting temperature of the coating agent (about 65° C. to about 70° C., or about 70° C.), the lattice formation of the crystal planes (e.g., lamellae) in the coating can be disrupted, the constituent molecules can adopt random orientations, and the coating can liquify.

In some embodiments, the third temperature is about 0° C. to about 50° C., for example, about 10° C. to about 40° C., about 20° C. to about 30° C., about 23° C. to about 27° C., or about 25° C. In some embodiments, the third temperature is greater than the temperature of the surrounding atmosphere. In some embodiments, the third temperature is less than the temperature of the surrounding atmosphere.

In some embodiments, the second temperature is maintained for about 5 seconds to about 10 hours. For example, the second temperature can be maintained for about 5 seconds to about 7 hours, about 5 seconds to about 3 hours, about 5 seconds to about 1.5 hours, about 5 seconds to about 60 minutes, about 30 seconds to about 45 minutes, about 5 minutes to about 60 minutes, about 10 minutes to about 45 minutes, about 20 minutes to about 40 minutes, about 25 minutes to about 35 minutes, about 30 seconds to about 10 minutes, about 30 seconds to about 7 minutes, about 30 seconds to about 3 minutes, about 3 minutes to about 7 minutes, about 30 seconds to about 1 minute, about 1 minute to about 5 minutes, about 25 minutes, about 27 minutes, about 29 minutes, about 30 minutes, about 32 minutes, about 35 minutes, about 30 seconds, about 1 minute, about 2 minutes, about 3 minutes, about 4 minutes, about 5 minutes, about 6 minutes, or about 7 minutes.

In some embodiments, the grain size after cooling the coating from the second temperature to the third temperature is larger than the grain size before heating the coating from the first temperature to the second temperature. In some embodiments, the grain size of the coating before heating the coated agricultural product from the first temperature to the second temperature is about 2 nm to about 10 nm, for example, about 5 nm to about 10 nm, about 8 nm to about 9 nm, about 8.5 nm to about 9.5 nm, about 9 nm to about 10 nm, about 8 nm, about 9 nm, or about 10 nm. For example, the grain size of the coating after cooling the coated agricultural product from the second temperature to the third temperature can be about 7 nm to about 100 nm, for example, about 8 nm to about 25 nm, about 11 nm to about 17 nm, about 11 nm to about 14 nm, about 13 nm to about 17 nm, about 12 nm to about 16 nm, about 15 nm to about 17 nm, about 11 nm, about 12 nm, about 13 nm, about 14 nm, about 15 nm, about 16 nm, or about 17 nm.

In another aspect, described herein is a method of reducing the mass loss rate of an agricultural product, the method comprising:
applying a dispersion comprising:
   a solvent, and
   one or more sucrose esters,
   one or more sorbitan esters, or
   one or more sucrose esters and one or more sorbitan esters to a surface of an agricultural product to yield a multiplicity of bilayers on the surface of the agricultural product; and
drying the dispersion on the surface of the agricultural product under a flow of air to promote self-assembly of a multiplicity of bilayers on the surface of the agricultural product, thereby yielding a coating comprising the one or more sucrose esters, the one or more sorbitan esters, or the one or more sucrose esters and the one or more sorbitan esters on the surface of the agricultural product.

In another aspect, described herein is a method of reducing the respiration rate of an agricultural product, the comprising:
applying a dispersion comprising:
   a solvent, and
   one or more sucrose esters,
   one or more sorbitan esters, or
   one or more sucrose esters and one or more sorbitan esters
to a surface of an agricultural product to yield a multiplicity of bilayers on the surface of the agricultural product; and
drying the dispersion on the surface of the agricultural product under a flow of air to promote self-assembly of a multiplicity of bilayers on the surface of the agricultural product, thereby yielding to yield a coating comprising the one or more sucrose esters, the one or more sorbitan esters, or the one or more sucrose esters and the one or more sorbitan esters the surface of the agricultural product.

In some embodiments, the concentration of the coating agent in the dispersion is about 10 g/L to about 200 g/L, for example, about 1 g/L to about 150 g/L, about 1 g/L to about 50 g/L, about 50 g/L to about 100 g/L, about 100 g/L to about 150 g/L, about 150 g/L to about 200 g/L, about 5 g/L to about 100 g/L, about 5 g/L to about 80 g/L, about 70 g/L to about 130 g/L, about 10 g/L to about 80 g/L, about 25 g/L to about 60 g/L, about 30 g/L to about 60 g/L, about 30 g/L to about 50 g/L, about 40 g/L to about 60 g/L, about 30 g/L to about 40 g/L, about 40 g/L to about 50 g/L, about 50 g/L to about 60 g/L, about 10 g/L, about 20 g/L, about 30 g/L, about 40 g/L, about 50 g/L, about 60 g/L, about 70 g/L, about 80 g/L, about 90 g/L, about 100 g/L, about 110 g/L, about 120 g/L, about 130 g/L or about 140 g/L.

In some embodiments, the dispersion is dried at a temperature of about 20° C. to about 100° C., for example, about 25° C. to about 80° C., about 25° C. to about 70° C., about 30° C. to about 65° C., about 40° C. to about 65° C., 50° C. to about 65° C., about 55° C. to about 65° C., about 60° C. to about 65° C., about 55° C., about 60° C., or about 65° C. In some embodiments, the dispersion is partially dried. In some embodiments, the drying removes greater than about 5% of the solvent, for example, greater than about 10%, 20%, 30%, 40%, 50%, 60%, 70%, 80%, 90%, or 95% of the solvent. In some embodiments, the bilayer structure forms when the dispersion is partially dried. In some embodiments, the bilayer structure forms after at least about 5% of the solvent has been removed, for example, after at least about 10%, 20%, 30%, 40%, 50%, 60%, 70%, 80%, 90%, or 95% of the solvent has been removed.

In some embodiments, faster solvent removal and/or drying can improve the performance of the coating. For example, faster solvent removal and/or drying can result in thicker and more homogeneous coatings. In some embodiments, removing the solvent or drying the dispersion is performed in under about 2 hours. For example, the solvent can be removed or dried in under about 1.5 hours, 1 hour, 45 minutes, 30 minutes, 25 minutes, 20 minutes, 15 minutes, 10 minutes, 5 minutes, 4 minutes, 2 minutes, 1 minute, 30 seconds, 15 seconds, 10 seconds, 5 seconds, or 3 seconds.

In another aspect, described herein is a method of coating an agricultural product, comprising:
applying a dispersion comprising one or more sucrose esters, or one or more sorbitan esters, and a solvent to a surface of an agricultural product;
drying the dispersion on the surface of an agricultural product under a flow of air to promote self-assembly of a multiplicity of bilayers on the surface of the agricultural product, thereby yielding a coating comprising the one or more sucrose esters, the one or more sorbitan esters, or the one or more sucrose esters and the one or more sorbitan esters the surface of the agricultural product.

In another aspect, described herein is a method of coating an agricultural product, comprising:
applying a dispersion comprising a coating agent and a solvent to the agricultural product, wherein a concentration of the coating agent in the dispersion is about 30 g/L to about 50 g/L;
drying the dispersion at a temperature of greater than about 50° C. to yield a coating on the agricultural product, wherein the coating comprises a bilayer structure having a grain size is about 13 nm to about 25 nm and a thickness of less than about 2 microns.

In another aspect, described herein is a method of coating an agricultural product, the method comprising:
applying a dispersion comprising a coating agent and a solvent to a surface of the agricultural product, wherein the coating agent comprises:
   one or more sucrose esters,
   one or more sorbitan esters, or
   one or more sucrose esters and one or more sorbitan esters; and
drying the dispersion at a temperature greater than about 60° C. to yield a coating on a surface of the agricultural product, thereby yielding a comprising the one or more sucrose esters, the one or more sorbitan esters, or the one or more sucrose esters and the one or more sorbitan esters the surface of the agricultural product wherein the coating has a thickness of less than about 2 microns and comprises a bilayer structure having the grain size of about 13 nm to about 25 nm.

In another aspect, described herein is a method of reducing the water permeability of a coating on a substrate, the method comprising:
applying a dispersion comprising:
   a solvent, and
   one or more sucrose esters,
   one or more sorbitan esters, or
   one or more sucrose esters and one or more sorbitan esters to a surface of an agricultural product; and
drying the dispersion under a flow of air to promote self-assembly of a multiplicity of bilayers on the surface of the agricultural product, thereby yielding a coating on the surface of the agricultural product, wherein the coating comprises the one or more sucrose esters, the one or more sorbitan esters, or the one or more sucrose esters and the one or more sorbitan esters.

In another aspect, described herein is a method of reducing the gas diffusion ratio of a coating on a substrate, comprising:
applying a dispersion comprising:
   a solvent, and
   one or more sucrose esters,
   one or more sorbitan esters, or
   one or more sucrose esters and one or more sorbitan esters to a surface of an agricultural product; and
drying the dispersion on the surface of an agricultural product under a flow of air to promote self-assembly of a multiplicity of bilayers on the surface of the agricultural product, thereby yielding a coating on the surface of the agricultural product, wherein the coating comprises the one or more sucrose esters, the one or more sorbitan esters, or the one or more sucrose esters and the one or more sorbitan esters.

In some embodiments, the substrate is an agricultural product, a silicon substrate, or a substrate comprising a polysaccharide (e.g., cellulose). For example, the substrate can be an agricultural product.

In another aspect, described herein is a method of reducing the mass loss rate of an agricultural product having a coating disposed thereon, the method comprising:
applying a dispersion comprising:
   a solvent, and
   one or more sucrose esters,
   one or more sorbitan esters, or
   one or more sucrose esters and one or more sorbitan esters to a surface of an agricultural product; and
drying the dispersion on the surface of the agricultural product under a flow of air to promote self-assembly of a multiplicity of bilayers on the surface of the agricultural product, thereby yielding a coating on the surface of the agricultural product, wherein the coating comprises the one or more sucrose esters, the one or more sorbitan esters, or the one or more sucrose esters and the one or more sorbitan esters.

In another aspect, described herein is a method of reducing the respiration rate of an agricultural product having a coating disposed thereon, the method comprising:
applying a dispersion comprising:
   a solvent, and
   one or more sucrose esters,
   one or more sorbitan esters, or
   one or more sucrose esters and one or more sorbitan esters to a surface of an agricultural product; and
drying the dispersion on the surface of the agricultural product under a flow of air to promote self-assembly of a multiplicity of bilayers on the surface of the agricultural product, promote self-assembly of a multiplicity of bilayers on the surface of the agricultural product, thereby yielding a coating on the surface of the agricultural product, wherein the coating comprises the one or more sucrose esters, the one or more sorbitan esters, or the one or more sucrose esters and the one or more sorbitan esters.

### Coating Thickness and Mass Loss Factor / Rate

In some embodiments, for coatings that are formulated to prevent water loss from or oxidation of coated substrates such as produce, thicker coatings will be less permeable to water and oxygen as compared to thinner coatings formed from the same coating agent, and should therefore result in lower mass loss rates as compared to thinner coatings. Thicker coatings can be formed by increasing the concentration of the coating agent in the dispersion and applying a similar volume of dispersion to each piece of (similarly sized) produce.

### Contact Angle / Wetting Agent

Without wishing to be bound by theory, it is believed that the sucrose esters or sorbitan esters that were added to the dispersions acted as surfactants / wetting agents, reducing the contact angle of the dispersion on the surface of the produce. In some embodiments, the addition of the wetting agents can improve coverage of the dispersion over the surface of the produce, thereby allowing a substantially contiguous coating to be formed over the entire surface. Consequently, the mass loss rates of coated produce were found to decrease with increasing coating thickness, and overall mass loss rates were found to be substantially reduced as compared to produce coated with similar dispersions that lacked the wetting agents. Additional evidence of these effects is provided below.

Through extensive experimentation, it was found that the contact angle of droplets of some solvents and coating solutions/suspensions on the surfaces of at least some types of produce was quite large, indicating a large difference in surface energy of the droplets as compared to the surface of the produce. This effect was particularly evident in cases where the dispersion was at least about 70% water by volume, since the surfaces of many plants or other agricultural products often tend to be hydrophobic due to the presence of epicuticular waxes. This phenomenon was characterized as follows. Droplets of solvent or coating (i.e., solvent with coating agent dissolved, suspended or dispersed therein) were deposited either directly on produce surfaces or directly on carnauba, candellila, or paraffin wax (carnauba, candellila, and paraffin wax all tend to have similar native hydrophobicity to that of the surfaces of lemons as well as many other types of produce), and contact angles were determined with image analysis software. Results of various studies are summarized as follows.

In some embodiments, increasing the concentration of the wetting agent (e.g., the sorbitan or sucrose esters) in water-based or high-water content coating dispersions decreased the contact angle of the dispersion on the produce or wax surface.

### EXAMPLES

The following examples describe effects of various coating agents and solutions/suspensions/colloids on various substrates, as well as characterization of some of the various coating agents and solutions/suspensions/colloids. These examples are only for illustrative purposes and are not meant to limit the scope of the present disclosure. In each of the examples below, all reagents and solvents were purchased and used without further purification unless specified.

In the Examples, “Treatment A” (or “Tmt. A”) refers to a 30/70 mixture of 2,3-dihydroxypropan-yl palmitate / 1,3-dihydroxypropan-2-yl palmitate in 100% ethanol of the indicated concentration. “Treatment B” (or “Tmt. B”) refers to a 60/5/35 mixture of monostearate / 1,3-dihydroxypropan-2-yl palmitate / palmitic acid in 100% ethanol. “Treatment C” (or “Tmt. C”) refers to a 95/5 monostearate / sodium stearate in 100% water. Treatment D” (or “Tmt. D”) refers to a 98/2 mixture of monostearate/sodium stearate in 100% water. Ratios (e.g., 30/70) refer to weight ratios.

### Example 1: Effect of Coatings Formed of Sucrose Esters on Mass Loss Rates of Californian Hass Avocados

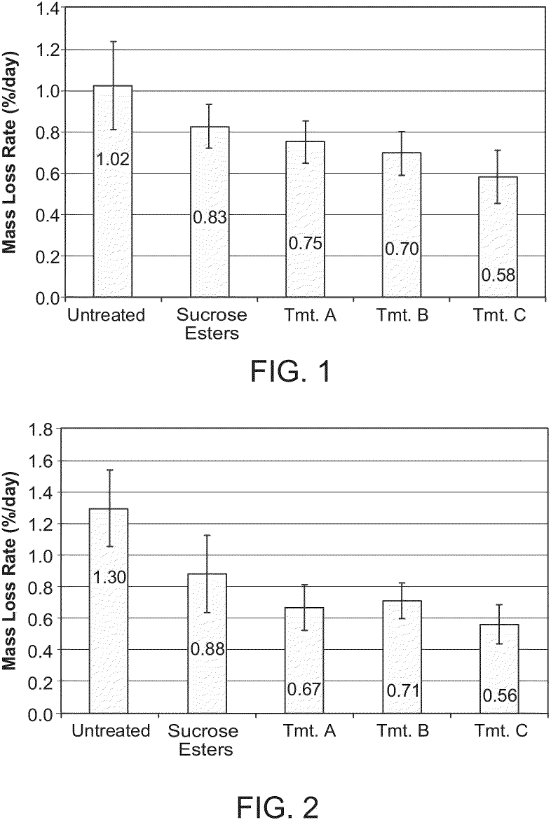

FIG. 1 is a graph showing average daily mass loss rates for Californian Hass Avocados. The avocados corresponding to the Untreated group were not treated. The avocados corresponding to the Sucrose Esters group were treated with 10 mg/mL sucrose palmitate in 100% ethanol. The avocados corresponding to the Treatment A group were treated with 10 mg/mL of Treatment A. The avocados corresponding to the Treatment B group were treated with 10 mg/mL of Treatment B. The avocados corresponding to the Treatment C group were treated with 30 mg/mL of Treatment C. The coating agents were each dissolved in solvent to form solutions, and solutions were applied to the surface of the corresponding avocados by bowl dipping and dried at 70° C. to form the coatings.

### Example 2: Effect of Coatings Formed of Sucrose Esters on Mass Loss Rates of Mexican Hass Avocados

FIG. 2 is a graph showing average daily mass loss rates for Mexican Hass Avocados. The avocados corresponding to the Untreated bar were not treated. The avocados corresponding to the Sucrose Esters bar were treated with 10 mg/mL sucrose palmitate in 100% ethanol. The avocados corresponding to the Treatment A group were treated with 10 mg/mL Treatment A. The avocados corresponding to the Treatment B group were treated with 10 mg/mL of Treatment B. The avocados corresponding to the Treatment C group were treated with 30 mg/mL of Treatment C. The coating agents were each dissolved in solvent to form solutions, and the solutions were applied to the surface of the corresponding avocados by bowl dipping and dried at 70° C. to form the coatings.

### Example 3: Effect of Coatings Formed of Sucrose Esters on Mass Loss Rates of Red Grape Tomatoes

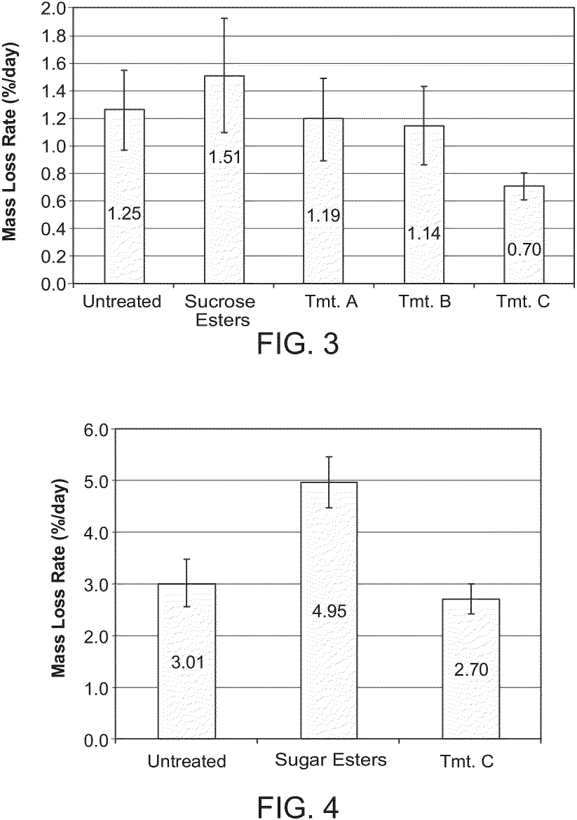

FIG. 3 is a graph showing average daily mass loss rates for red grape tomatoes. The tomatoes corresponding to the Untreated group were not treated. The tomatoes corresponding to the Sucrose Esters group were treated with 10 mg/mL sucrose palmitate in 100% ethanol. The tomatoes corresponding to the Treatment A group 10 treated with mg/mL of a Treatment A. The tomatoes corresponding to the Treatment B group were treated with 10 mg/mL of Treatment B. The tomatoes corresponding to the Treatment C group were treated with 30 mg/mL of Treatment C. The coating agents were each dissolved in solvent to form solutions, and the solutions were applied to the surface of the corresponding tomatoes by bowl dipping and dried at 70° C. to form the coatings.

### Example 4: Effect of Coatings Formed of Sucrose Esters on Mass Loss Rates of Peaches

FIG. 4 is a graph showing average daily mass loss rates for peaches. The peaches corresponding to the Untreated group were not treated. The peaches corresponding to the Sugar (Sucrose) Esters group were treated with 10 mg/mL sucrose palmitate in 100% ethanol. The peaches corresponding to the Treatment C group were treated with 10 mg/mL of Treatment C. The coating agents were each dissolved in solvent to form solutions, and the solutions were applied to the surface of the corresponding peaches by bowl dipping and dried at 70° C. to form the coatings.

### Example 5: Effect of Coatings Formed of Sucrose Esters on Mass Loss Rates of Peaches

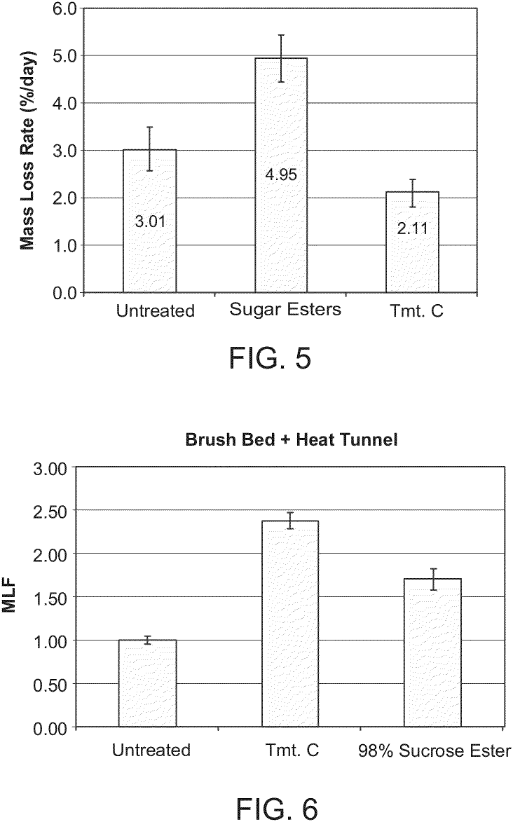

FIG. 5 is a graph showing average daily mass loss rates for peaches. The peaches corresponding to the Untreated group were not treated. The peaches corresponding to the Sugar (Sucrose) Esters group were treated with 10 mg/mL sucrose palmitate in 100% ethanol. The peaches corresponding to the Treatment C group were treated with 30 mg/mL of Treatment C. The coating agents were each dissolved in solvent to form solutions, and the solutions were applied to the surface of the corresponding peaches by bowl dipping and dried at 70° C. to form the coatings.

### Example 6: Effect of Coatings Formed of Sucrose Esters on Mass Loss Factors and Respiration Rates of Avocados

FIG. 6 is a graph showing mass loss factors for avocados. The avocados corresponding to the Untreated group were not treated. The products corresponding to the Treatment C group were treated with 30 g/L of Treatment C in DI water. The products corresponding to the Sucrose Ester group were treated with 30 g/L sucrose palmitate (98 wt%) and sodium monostearate (2 wt%) in DI water. The coating agents were each mixed in 60° C. DI water using high shear mixing (1600 RPM for 5 minutes). The avocados were treated using a brush bed and dried in a heat tunnel at 70° C.

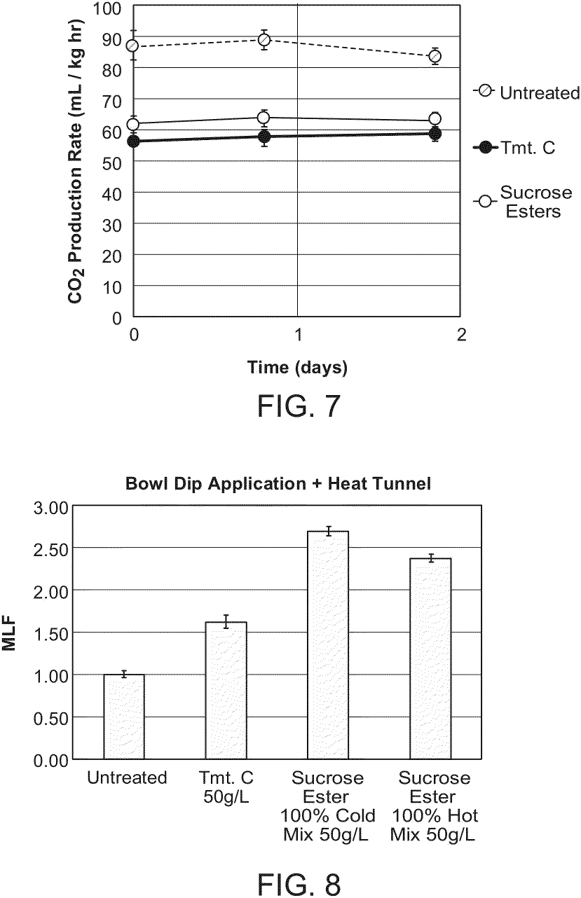

FIG. 7 is a graph showing respiration rates for the avocados. The avocados treated with sucrose esters had a mass loss factor of 1.70 and a respiration factor of 1.38 on day 2. The avocados treated with monoglyceride (95/5 monostearate/sodium stearate) had a mass loss factor of 2.38 and a respiration factor of 1.55 on day 2.

### Example 7: Effect of Coatings Formed of 100% Sucrose Esters on Mass Loss Factors and Respiration Rates of Mexican Avocados

FIG. 8 is a graph showing mass loss factors for Mexican avocados. The Untreated group were not treated. The Treatment C group were treated with 50 g/L of Treatment C prepared using a Silverson high shear mixer. The Sucrose Ester 100% cold mix group were treated with 50 g/L sucrose ester (100 wt%) in water, which was prepared by mixing at room temperature for 1 minute using a Vitamix blender. The Sucrose Ester 100% hot mix group were treated with 50 g/L sucrose ester (100 wt%) in water, which was prepared by mixing at 80° C. for 3 minutes using a Vitamix. The coatings were applied using a bowl dip method and dried under heat tunnel conditions.

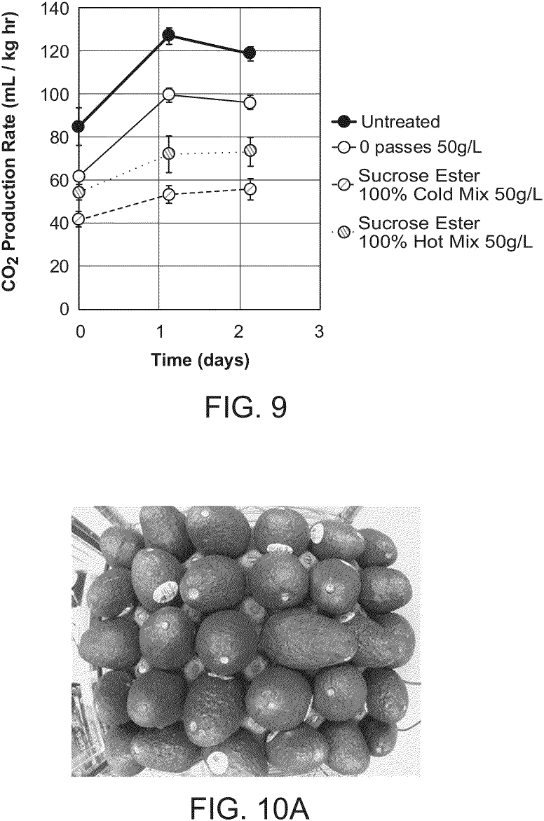

FIG. 9 is a graph showing the respiration rates for the Mexican avocados. As shown in FIG. 8 and FIG. 9, the cold-mixed sucrose ester coating performed roughly twice as well as the monoglyceride (98/2 sucrose palmitate/sodium stearate) coating in terms of both moisture retention and respiration reduction.

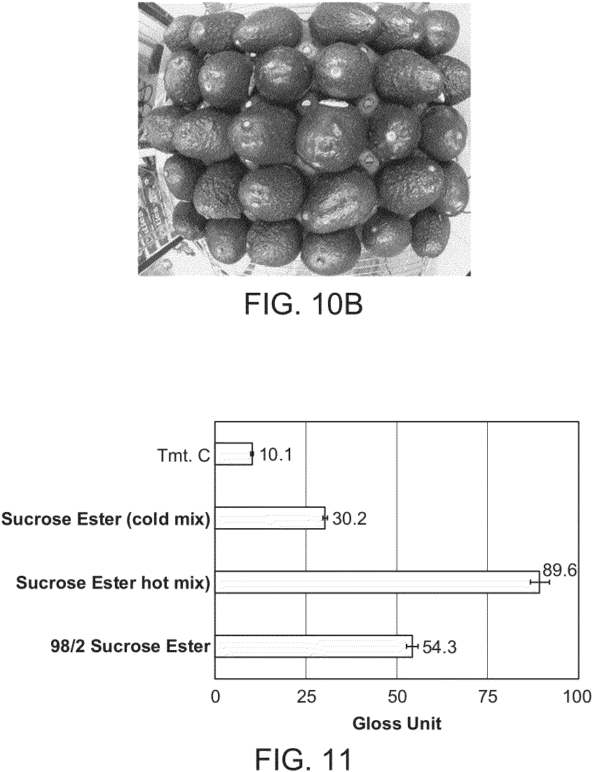

FIG. 10A is an image of the Mexican avocados that are untreated, and FIG. 10B is an image of the Mexican avocados treated with the hot-mixed sucrose ester coating. As can be seen in FIGS. 10A and 10B, the avocados treated with the hot-mixed sucrose ester coating have a higher gloss than the untreated Mexican avocados.

### Example 8: Effect of Coatings Formed of Sucrose Esters on Gloss of Thin Films

FIG. 11 is a graph showing gloss units for thin films of various compositions. One film was formed from 50 g/L of Treatment C. A second film was formed from 50 g/L of sucrose ester (100 wt%) in water using a cold mix process. A third film was formed from 50 g/L of sucrose ester (100 wt%) in water using a hot mix process. A fourth film was formed from 50 g/L of 98/2 mixture of sucrose ester/sodium stearate. Dispersions of 50 g/L of each composition were mixed in a Vitamix blender for 3 minutes on the maximum setting. The dispersion (0.5 mL) was then deposited onto a plastic microscope coverslip. The films were ambient dried, and the gloss was measured using a Horiba IG-320 glossmeter. The Horiba IG-320 measured 60-degree light reflection and was calibrated using the reflection of black glass. As shown in FIG. 11, the films containing sucrose esters resulted in gloss units much higher than the monoglyceride coating. The error bars are standard deviation of gloss unit measurement across 3 trials. A higher gloss unit is an indication of greater light reflection from the film.

### Example 9: Mixing Studies of Sucrose Ester Mixtures

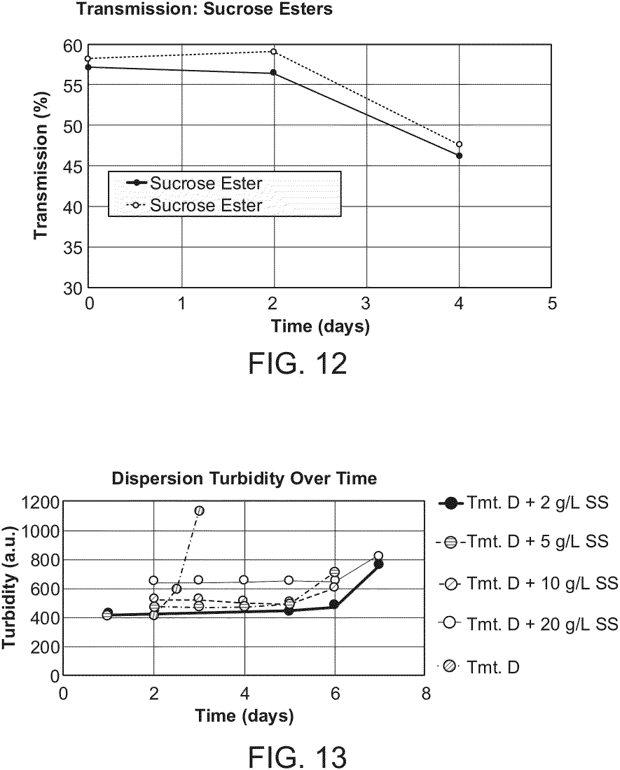

FIG. 12 is a graph showing transmission of two different sucrose ester mixtures. One mixture comprised 50 g/L of sucrose ester (100 wt%) in water and was prepared using a cold mix process. A second mixture comprised 50 g/L of sucrose ester (100 wt%) in water and was prepared using a hot mix process. Two types of sucrose esters were mixed with monostearate in 80° C. water using a Vitamix blender at the maximum setting for 3 minutes.

FIG. 13 is a graph showing turbidity over time for monoglyceride dispersions with varying amounts of sucrose ester additives (sucrose stearate or “SS”). The monoglyceride solution (Treatment D) comprises a 98/2 mixture of monostearate/sodium stearate in 100% water at a concentration (Tmt. D) of 50 g/L. The dispersions were created by blending in hot water in a Vitamix blender for 3 minutes. The turbidity of the dispersions was monitored with a turbidimeter over time. As shown in FIG. 13, the addition of sucrose stearate leads to a 2 to 3-fold increase in the dispersion stability, determined by the change in turbidity as compared to those containing no sucrose stearate.

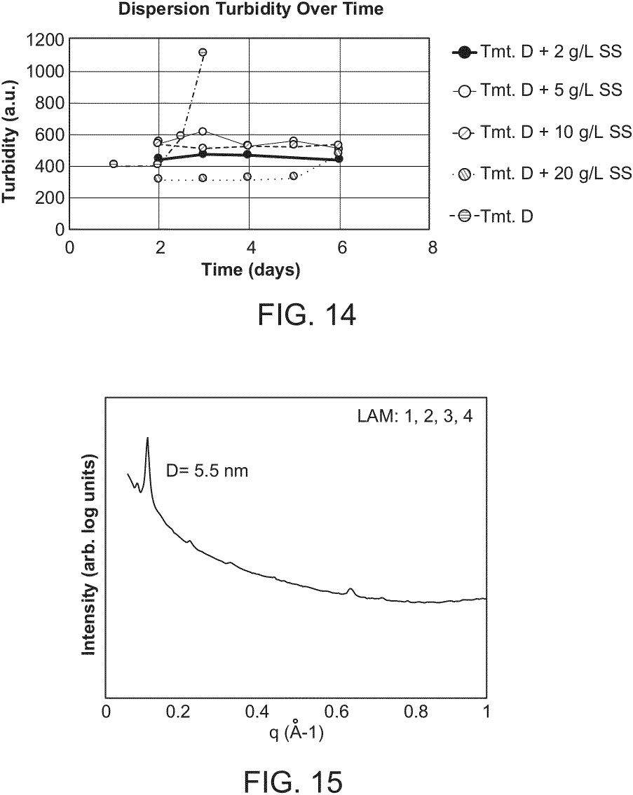

FIG. 14 is a graph showing turbidity over time for monoglyceride dispersions with varying amounts of sucrose ester additives (sucrose stearate or “SS”). The monoglyceride solution (Treatment D) comprises a 98/2 mixture of monostearate/sodium stearate in 100% water at a concentration of 50 g/L. The sucrose ester additive is a mixture of sucrose fatty acid ester (≥ 90 wt%), free fatty acid (as oleic acid, ≤ 3 wt%), free sucrose (≤ 4 wt%), and water (≤ 4 wt%), available from Sisterna B.V. The dispersions were created by blending in hot water (80°) in a Vitamix blender for 3 minutes. The turbidity of the dispersions was monitored with a turbidimeter over time. As shown in FIG. 14, the addition of sucrose stearate leads to a 2 to 3-fold increase in the dispersion stability, determined by change in turbidity, as compared to those containing no sucrose stearate.

### Example 10: Structure of Sorbitan Ester Coatings Measured by X-Ray Scattering

Coating agents were applied to the surface of a plastic substrate, which acts as a hydrophilic surface when exposed to air. An X-ray scattering image of the applied coat was obtained to identify characteristics of the coating.

Specifically, a coating agent of sorbitan monostearate (95 wt%) and sodium stearate (5 wt%) was applied to a substrate as a thin-film. The films were drop cast from a 30 g/L aqueous solution and dried at 40° C. for 4 hours. As shown in FIG. 15, sorbitan monostearate was found to self-assemble into alternating bilayers with a periodicity of 5.5 nm. “LAM” refers to lamellar or bilayer morphology.

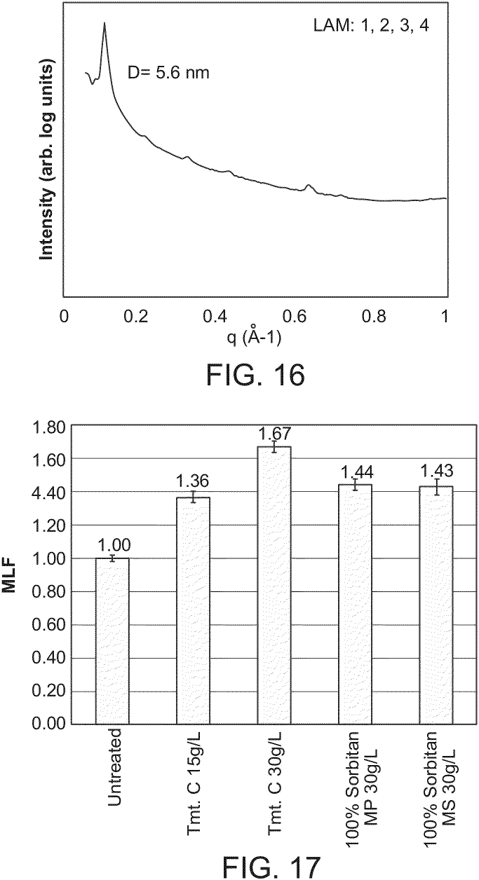

In addition, a coating agent of sorbitan monopalmitate (95 wt%) and sodium stearate (5 wt%) was applied to the substrate as a thin-film. The films were cast from a 30 g/L aqueous solution and dried for 40° C. for 4 hours. As shown in FIG. 16, sorbitan monopalmitate was found to self-assemble into alternating bilayers with a periodicity of 5.6 nm.

### Example 11: Effect of Coatings Formed of Sorbitan Esters on Mass Loss Factors and Respiration Rates of California Avocados

FIG. 17 is a graph showing mass loss factors for California avocados. The Untreated group of avocadoes was not treated. A second group of avocados was treated with 15 g/L of Treatment C. A third group of avocados was treated with 30 g/L of Treatment C. A fourth group of avocados was treated with 30 g/L sorbitan monopalmitate (MP) (100 wt%). A fifth group of avocados was treated with a 30 g/L sorbitan monostearate (MS). The sorbitan ester coatings were prepared by dispersing the sorbitan ester in DI water. The coatings were applied using a bowl dip method and were dried under a flow of air at a temperature of 70° C. As shown in FIG. 17, sorbitan ester films were found to reduce the dehydration and offer similar performance to Treatment C at a concentration of 15 g/L.

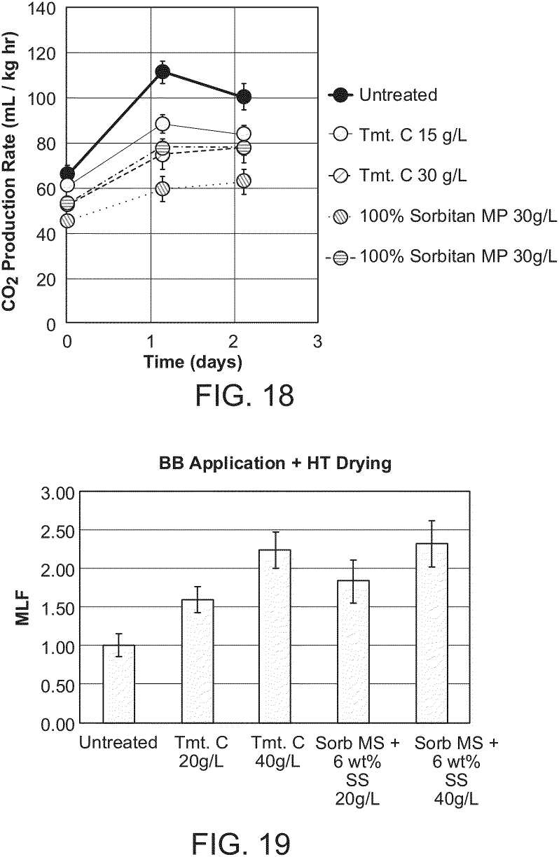

FIG. 18 is a graph showing the respiration rates for the California avocados. As shown in FIG. 18, the sorbitan ester films were found to exhibit comparable (sorbitan monostearate) or higher (sorbitan monopalmitate) respiration factors as compared to the 95/5 mixture of monostearate/sodium stearate at 30 g/L.

### Example 12: Effect of Coatings Formed of Sorbitan Esters on Mass Loss Factors and Respiration Rates of Mexican Avocados

FIG. 19 is a graph showing mass loss factors (MLF) for Mexican avocados. A first group of avocados was not treated. A second group of avocados was treated with 20 g/L of Treatment C. A third group of avocados was treated with 40 g/L of Treatment C. The monoglyceride coatings were mixed with a high shear mixer. A fourth group of avocados was treated with 20 g/L of a mixture of sorbitan monostearate (94 wt%) and sodium stearate (6 wt%). A fifth group of avocados was treated with 40 g/L of a mixture of sorbitan monostearate (94 wt%) and sodium stearate (6 wt%). The sorbitan monostearate coatings were mixed with blenders. The coatings were applied using a brush bed and were dried at a temperature of 70° C. As shown in FIG. 19, moisture barrier performance between the monoglyceride and sorbitan monostearate films were found to be similar. The MLF of 20 g/L of 95/5 monostearate/sodium stearate was 1.49 and the MLF of the 40 g/L 95/5 monostearate/sodium stearate was 2.24. The sorbitan monostearate 20 g/L group had a MLF of 1.83 and sorbitan monostearate 40 g/L group had a MLF of 2.32.

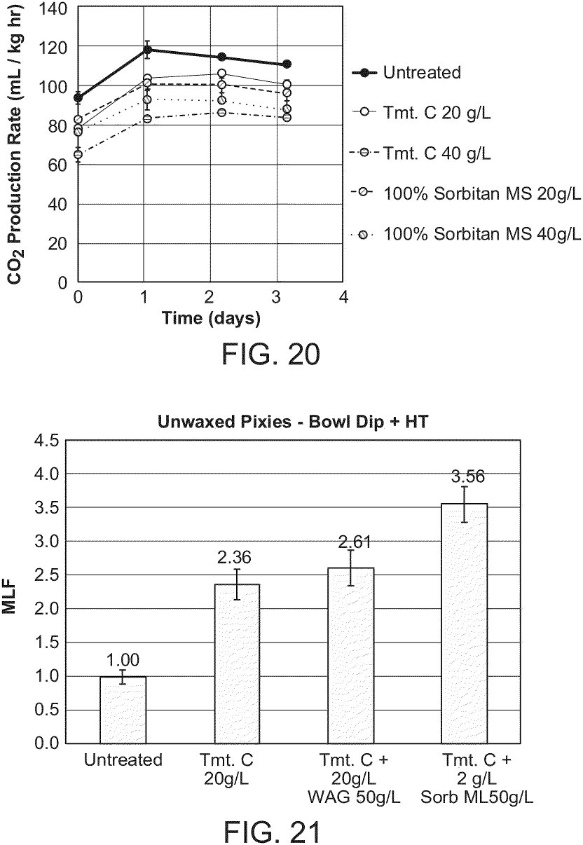

FIG. 20 is a graph showing the respiration rates for the Mexican avocados. As shown in FIG. 20, the respiration performance between sorbitan monostearate and monoglyceride compositions were found to be similar. On day 1, 20 g/L Treatment C RF was 1.17 and 40 g/L Treatment C RF was 1.43. The sorbitan monostearate 20 g/L group had an RF of 1.15 and the 40 g/L group had an RF of 1.25.

### Example 13: Effect of Coatings With Sorbitan Monolaurate Wetting Agent on Mass Loss Factors on Unwaxed Pixie Oranges

FIG. 21 is a graph showing mass loss factors for unwaxed pixie oranges (“pixies”). One group of pixies was not treated. A second group of pixies was treated with 50 g/L of Treatment C. A third group of pixies was treated with 50 g/L of Treatment C and 2 g/L of a wetting agent (WAG). A fourth group of pixies was treated with 50 g/L of a 95/5 mixture of monostearate/sodium stearate and 2 g/L sorbitan monolaurate. The coatings were applied using a bowl dip method and were dried at a temperature of 70° C. As shown in FIG. 21, adding 2 g/L of sorbitan monolaurate to the monoglycerides increased the mass loss factor 3.56 times compared to the untreated substrates. The pixies were mostly dry (~80%) coming out of the heat tunnel.

### Example 14: Synthesis of Erythritol and Xylitol Monoesters of Fatty Acids

In a dry 500 mL round bottom flask containing a stir bar was added 10 g of vinyl stearate and 1.05 eq of the appropriate sugar alcohol, followed by flushing with nitrogen and canula transfer of 400 mL of t-butanol that had been dried over 3 Å molecular sieves. This was heated to 57° C. and stirred for 4 hours to partially dissolve the sugar alcohol. To this was added 1 g of an immobilized CalB enzyme. After 3 days, some degree of stearic acid and unreacted starting vinyl alcohol was detected by TLC. An additional 0.5 eq of sugar alcohol was added along with another 1 g of an immobilized CalB enzyme, and stirred for an additional day. The reaction was then hot filtered to remove the enzyme resin and lyophilized to dryness. Small portions of the material were purified by column chromatography to give the target esters for testing. NMR analysis indicates that the isolated materials are a mixture of two connectivity isomers, with the 1-yl isomer being dominant. Alternatively, these materials can be synthesized by switching the enzyme catalyst for an appropriate base catalyst (e.g., potassium t-butoxide).

Characterization data for the erythritol monoester of stearic acid (2,3,4-trihydroxybutyl stearate and 1,3,4-trihydroxybutan-2-yl stearate) are listed below. For simplicity, stereochemistry is omitted.
Rf: 0.45 (EtAc)
¹H NMR (600 MHz, 1:1 CDCl₃:d₄-MeOD) δ 4.89 - 4.80 (m, 0.1H, 2-yl), 4.28 (dd, J = 11.4, 3.0 Hz, 1H), 4.13 (dd, J = 11.7, 6.5 Hz, 1H), 3.77 - 3.68 (m, 2H), 3.63 (dd, J = 11.3, 5.9 Hz, 1H), 3.56 (td, J = 6.4, 3.9 Hz, 1H), 2.33 (t, J = 7.6 Hz, 2H), 1.60 (p, J = 7.4 Hz, 2H), 1.23 (s, 31H), 0.85 (t, J = 6.9 Hz, 3H).
¹³C NMR (151 MHz, 1:1 CDCl₃:d₆-DMSO, ref DMSO) δ 173.40, 72.41, 70.10, 66.41, 63.60, 34.11, 31.78, 29.53, 29.49, 29.39, 29.24, 29.19, 29.04, 24.88, 22.56, 14.28.

Characterization data for the xylitol monoester of stearic acid (2,3,4,5-tetrahydroxypentyl stearate and 1,3,4,5-tetrahydroxypentan-2-yl stearate, potentially 1,2,4,5-tetrahydroxypentan-3-yl stearate) are listed below. For simplicity, stereochemistry is omitted.
Rf: 0.25 (EtAc)
¹H NMR (600 MHz, 1:1 CDCl₃:d₄-MeOD) δ 5.00 (d, J = 4.9 Hz, 0.2H, 2-yl), 4.16 (dd, J = 5.8, 3.1 Hz, 2H), 3.95 - 3.87 (m, 1H), 3.77 - 3.69 (m, 1H), 3.67 - 3.57 (m, 3H), 2.32 (t, J= 7.5 Hz, 2H), 1.59 (p, J = 7.3 Hz, 2H), 1.23 (s, 31H), 0.85 (t, J = 6.9 Hz, 3H).
¹³C NMR (151 MHz, 1:1 CDCl₃:d₄-MeOD) δ 174.45, 72.53, 70.44, 70.27, 65.38, 63.02, 34.12, 33.95, 31.75, 29.50, 29.46, 29.43, 29.32, 29.30, 29.17, 29.15, 29.12, 29.00, 28.97, 24.71, 22.47, 13.60.

### Example 15: Preparation and Analysis of Sugar Alcohol Ester Dispersions

100 wt% sugar alcohol ester, or 95%/5 wt% sugar alcohol ester/sodium stearate mixtures were added to vials, followed by the appropriate amount of deionized water to make 25 g/L solutions. The vials were capped and sonicated in hot water (~85° C.) until such time as the material went into solution and was homogenous. The vials were removed and the resulting dispersions tested for thermal and contact angle properties. In contrast to the monoglycerides, the sugar alcohol esters were capable of dispersion without the presence of sodium stearate.

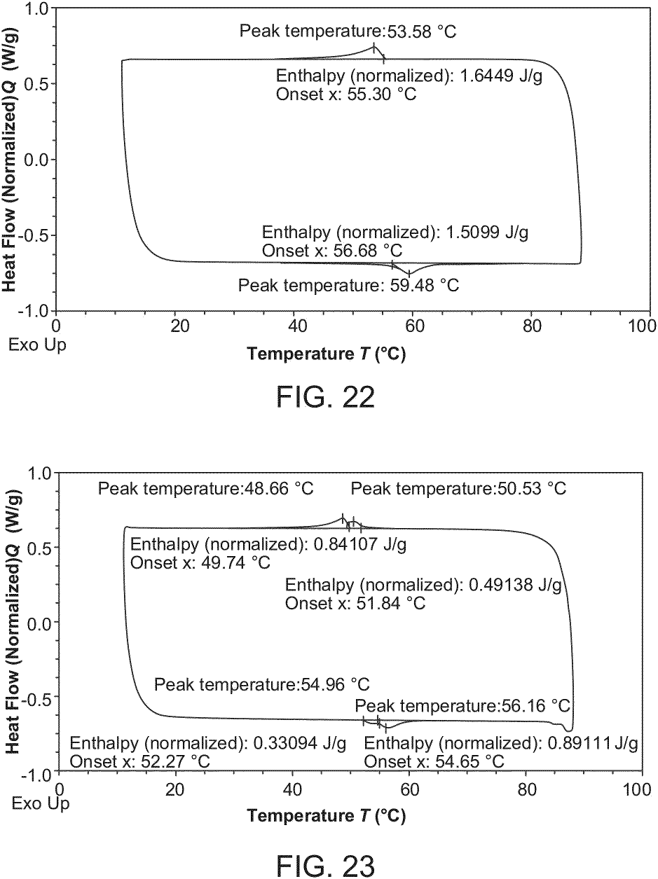

Samples of the dispersions were loaded into Al hermetic sealing pans and cycled from 10° C. to 90° C. at 10° C./min ramp rates on a TA Instruments DSC 250. Without wishing to be bound to theory, the liquid crystalline -> α-gel phase change temperature slightly decreased as the head group size increased (55° C., 52° C., 50° C. for the monoglyceride, monoerythritide, and monoxylitide ester, respectively). The inclusion of sodium stearate, however, disrupts the crystalline order of the putative bilayers, as evidenced by significant broadening of the thermal transitions and lower enthalpy associated with the transition. Table 2 shows onset temperature, peak temperature, and enthalpy for dispersions prepared according to Example 15. DSC plots for these dispersions are shown in FIGS. 22-26.

Table 2

Onset temperature, peak temperature, and enthalpy for dispersions of Example 15

| | Onset Temp (°C) | Peak Temp (°C) | Enthalpy (J/g) |
|---|---|---|---|
| 95/5 C18 Glycerol Ester/Sodium Stearate | 55.3 | 53.6 | 1.645 |
| 100/0 C18 Erythritol Ester/ Sodium Stearate | 51.8 | 50.5 | 1.388 |
| 95/5 C18 Erythritol Ester/ Sodium Stearate | 51.3 | 46.6 | 1.111 |
| 100/0 C18 Xylitol Ester/ Sodium Stearate | 49.9 | 48.9 | 1.421 |
| 95/5 C18 Xylitol Ester/ Sodium Stearate | 51.7 | 46.42 | 1.153 |

FIG. 22 shows a DSC plot for a 95/5 C18 glycerol ester/sodium stearate, 25 g/L dispersion.

FIG. 23 shows a DSC plot for a 100/0 C18 erythritol ester/sodium stearate, 25 g/L dispersion.

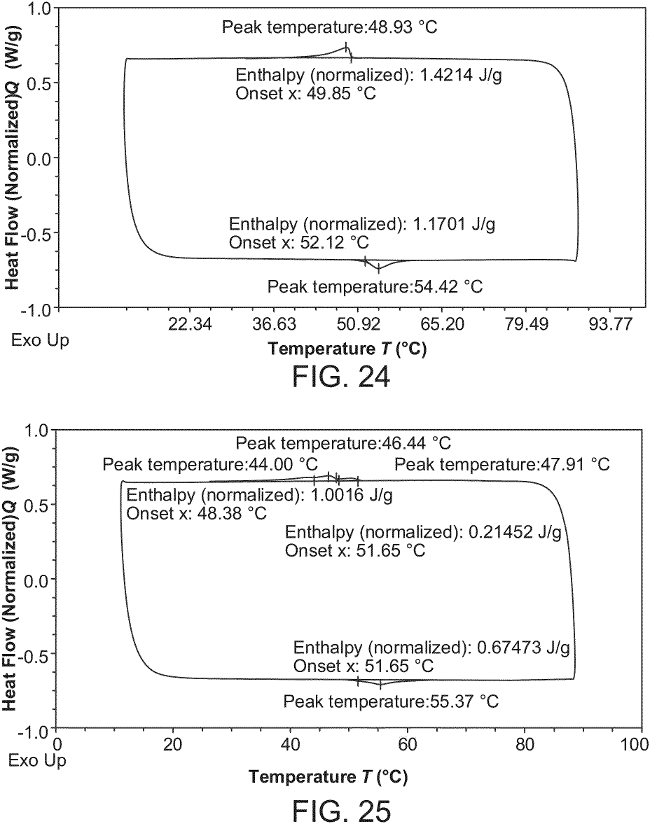

FIG. 24 shows a DSC plot for a 95/5 C18 erythritol ester/sodium stearate, 25 g/L dispersion.

FIG. 25 shows a DSC plot for a 100/0 C18 xylitol ester/sodium stearate, 25 g/L dispersion.

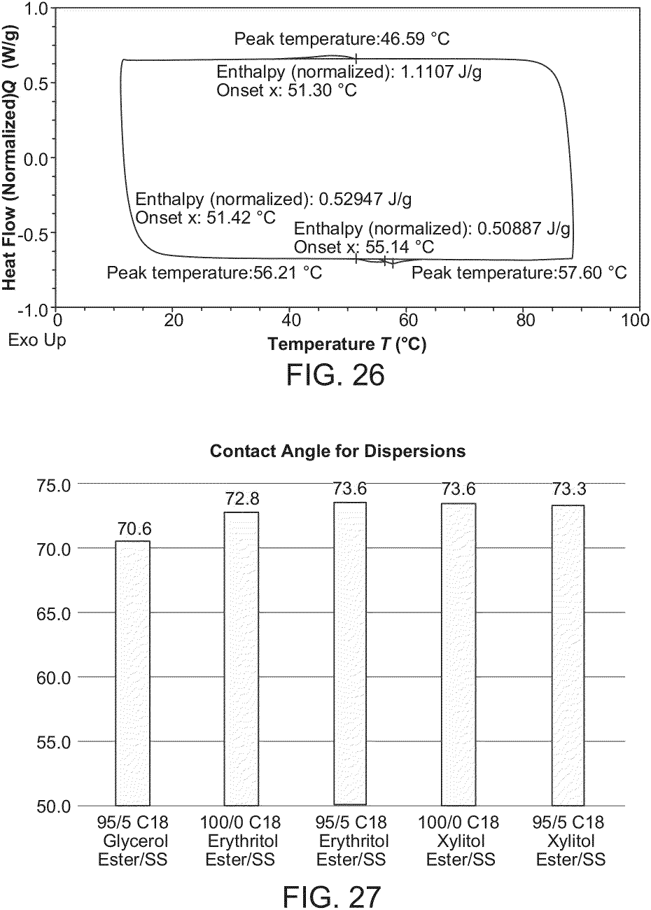

FIG. 26 shows a DSC plot for a 95/5 C18 xylitol ester/sodium stearate, 25 g/L dispersion.

Each dispersion listed in Table 2 was dropped onto a polycarbonate microscope slide cover. After 60 seconds, the contact angle was measured on a Kruss DSA 25S. FIG. 27 shows contact angles for the dispersions listed in Table 2.

While various compositions and methods have been described above, it should be understood that they have been presented by way of example only, and not limitation. Where methods and steps described above indicate certain events occurring in certain order, ordering of steps may be modified, and such modification are in accordance with the variations of the invention. Additionally, certain of the steps may be performed concurrently in a parallel process when possible, as well as performed sequentially as described above. The various implementations have been particularly shown and described, but it will be understood that various changes in form and details may be made. Accordingly, other implementations are within the scope of the following claims.

### Example 16: Effect of Ester-Containing Coatings on Mass Loss Factors of Conventional Limes

Conventional limes were treated according to Table 3. The coatings were applied using a bowl dip method and were dried under a flow of air at a temperature of 70° C.

Table 3

Lime Treatments

| Group | Treatment |
|---|---|
| 1 | Untreated |
| 2 | 25 g/L of Treatment C and 1 g/L of a wetting agent (WAG) |
| 3 | 25 g/L of Sucrose Stearate A |
| 4 | 25 g/L of Sucrose Stearate B |
| 5 | 25 g/L of Sucrose Stearate C |
| 6 | 47.5 g/L of Treatment C and 2.5 g/L of WAG |
| 7 | 47.5 g/L of Treatment C and 2.5 g/L of ethoxylated sorbitan monolaurate |
| 8 | 47.5 g/L of Treatment C and 2.5 g/L of glucose ester |

Mass loss factors (MLF) were determined for Groups 1-8. The results are shown in Table 4.

Table 4

MLF of Treated Limes

| Group | MLF |
|---|---|
| 1 | 1.00 |
| 2 | 1.27 |
| 3 | 1.21 |
| 4 | 1.16 |
| 5 | 1.12 |
| 6 | 1.29 |
| 7 | 1.26 |
| 8 | 1.28 |

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of reducing the ripening rate of an agricultural product, the method comprising:
applying a dispersion comprising:
one or more sucrose esters,
one or more sorbitan esters, or
one or more sucrose esters and one or more sorbitan esters to a surface of the agricultural product; and
drying the dispersion on the surface of the agricultural product under a flow of air to promote self-assembly of a multiplicity of bilayers on the surface of the agricultural product, thereby forming a coating comprising the one or more sucrose esters, the one or more sorbitan esters, or the one or more sucrose esters and the one or more sorbitan esters on the agricultural product.

2. The method of claim 1, wherein each of the one or more sucrose esters has an ester chain length of C₁₀ to C₂₄.

3. The method of claim 1, wherein the one or more sucrose esters comprise one or more of sucrose palmitate, sucrose stearate, and sucrose laurate.

4. The method of claim 1, wherein each of the one or more sorbitan esters has an ester chain length of C₁₀ to C₂₄.

5. The method of claim 1, wherein the one or more sorbitan esters comprise one or more of sorbitan stearate, sorbitan palmitate, and sorbitan laurate.

6. The method of claim 1, wherein the dispersion further comprises one or more fatty acid derivatives.

7. The method of claim 1, wherein a total concentration of the one or more sucrose esters and the one or more sorbitan esters in the dispersion is between 30 mg/mL and 125 mg/mL.

8. The method of claim 1, wherein the dispersion is free of added stabilizer, added surfactant, or both.

9. The method of claim 1, wherein a temperature of the air is between 50° C. and 100° C.

10. The method of claim 1, wherein the multiplicity of bilayers comprises one or more open bilayers.

11. The method of claim 10, wherein each bilayer in the multiplicity of bilayers is an open bilayer.

12. The method of claim 10, wherein one or more of the open bilayers are lamellar.

13. The method of claim 1, wherein the multiplicity of bilayers comprises one or more closed bilayers.

14. The method of claim 13, wherein each bilayer in the multiplicity of bilayers is a closed bilayer.

15. The method of claim 13, wherein one or more of the closed bilayers are each independently spherical or cylindrical.

16. A coated agricultural product comprising:
an agricultural product; and
a coating on a surface of the agricultural product, wherein the coating comprises:
one or more sucrose esters,
one or more sorbitan esters, or
one or more sucrose esters and one or more sorbitan esters, and
a multiplicity of bilayers on the surface of the agricultural product.

17. The product of claim 16, wherein the multiplicity of bilayers comprises one or more open bilayers.

18. The product of claim 17, wherein each bilayer in the multiplicity of bilayers is an open bilayer.

19. The product of claim 16, wherein the multiplicity of bilayers comprises one or more closed bilayers.

20. The product of claim 19, wherein each bilayer in the multiplicity of bilayers is a closed bilayer.
